(19) United States
(12) Patent Application Publication
(10) Pub. No.: US 2018/0040044 A1
(43) Pub. Date: Feb. 8, 2018

(54) VECTOR-BASED CHARACTERIZATIONS OF PRODUCTS AND INDIVIDUALS WITH RESPECT TO PERSONAL PARTIALITIES

(71) Applicant: Wal-Mart Stores, Inc., Bentonville, AR (US)

(72) Inventors: Todd D. Mattingly, Bentonville, AR (US); Jason R. Todd, Lowell, AR (US); Tim W. Webb, Rogers, AR (US)

(21) Appl. No.: 15/669,546

(22) Filed: Aug. 4, 2017

Related U.S. Application Data
(60) Provisional application No. 62/370,853, filed on Aug. 4, 2016.
(60) Provisional application No. 62/370,848, filed on Aug. 4, 2016.
(60) Provisional application No. 62/436,842, filed on Dec. 20, 2016.
(60) Provisional application No. 62/377,113, filed on Aug. 19, 2016.
(60) Provisional application No. 62/485,045, filed on Apr. 13, 2017.

(51) Int. Cl. G06Q 30/06; G06T 7/70; G06T 11/60

(52) U.S. Cl. CPC G06Q 30/0617; G06Q 30/0643; G06T 11/60; G06T 7/70; G06T 2200/24

(57) ABSTRACT

Some embodiments comprise a system to support customers while shopping, comprising: a plurality of virtual reality rendering systems; a field of expertise database associating each of multiple products with one or more of multiple different fields of expertise and with one of multiple different virtual reality environments; a central control system configured to: identify a product for which a customer is requesting expert advice; access a virtual reality content database and acquire a set of code to be applied in rendering a virtual reality environment corresponding to the field of expertise and the product; and distribute the set of code to a rendering system corresponding to the customer to cause the rendering system to visually render the virtual reality environment and an expert avatar.

### RELATED APPLICATION(S)

This application claims the benefit of U.S. Provisional application No. 62/436,842, filed Dec. 20, 2016, U.S. Provisional application No. 62/485,045, filed Apr. 13, 2017, U.S. Provisional application No. 62/370,853, filed Aug. 4, 2016, U.S. Provisional application No. 62/370,848, filed Aug. 4, 2016, and U.S. Provisional application No. 62/377,113, filed Aug. 19, 2016, which are all incorporated by reference in their entirety herein.

### TECHNICAL FIELD

These teachings relate generally to providing products and services to individuals.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 illustrates a simplified block diagram of an exemplary customer service and support system that is associated with one or more retail shopping facilities, in accordance with some embodiments;

FIG. 19 illustrates a simplified flow diagram of an exemplary process of supporting customers while shopping and providing customers with expert advice, in accordance with some embodiments;

FIG. 20 illustrates a simplified block diagram of an exemplary customer service and support system that is associated with one or more retail shopping facilities, in accordance with some embodiments;

FIG. 21 illustrates a simplified flow diagram of an exemplary process of supporting customers while shopping and providing customers with expert advice, in accordance with some embodiments;

FIG. 22 illustrates a simplified flow diagram of an exemplary process of supplying advice to customers while the customers are shopping, in accordance with some embodiments;

FIG. 23 comprises a block diagram as configured in accordance with various embodiments of these teachings;

FIG. 24 comprises a schematic diagram as configured in accordance with various embodiments of the invention;

FIG. 25 comprises a schematic diagram as configured in accordance with various embodiments of these teachings;

FIG. 26 comprises a screen shot as configured in accordance with various embodiments of the invention;

FIG. 27 comprises a screen shot as configured in accordance with various embodiments of these teachings;

FIG. 28 comprises a schematic block diagram as configured in accordance with various embodiments of these teachings;

FIG. 29 comprises a flow diagram as configured in accordance with various embodiments of these teachings; and

FIG. 30 illustrates an exemplary system for use in implementing methods, techniques, devices, apparatuses, systems, servers, sources and providing access to customer advice and support, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

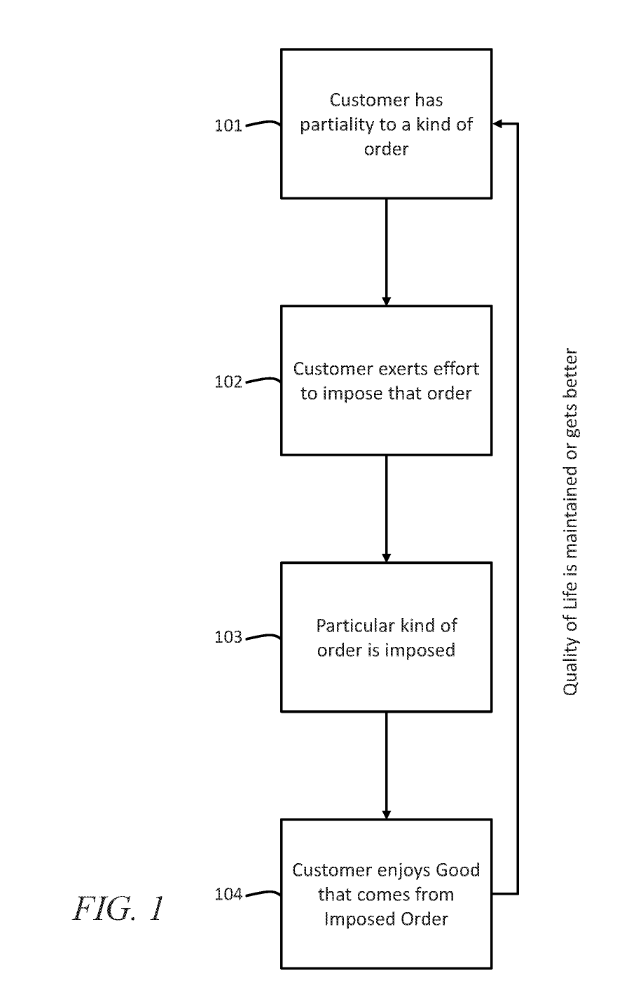

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

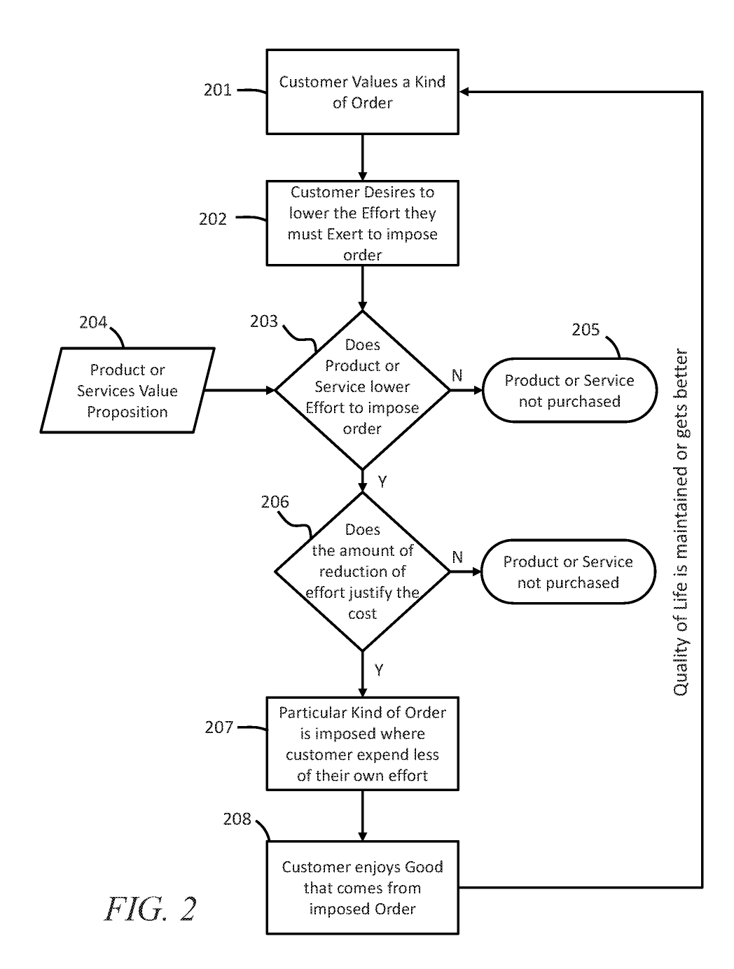

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture- based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

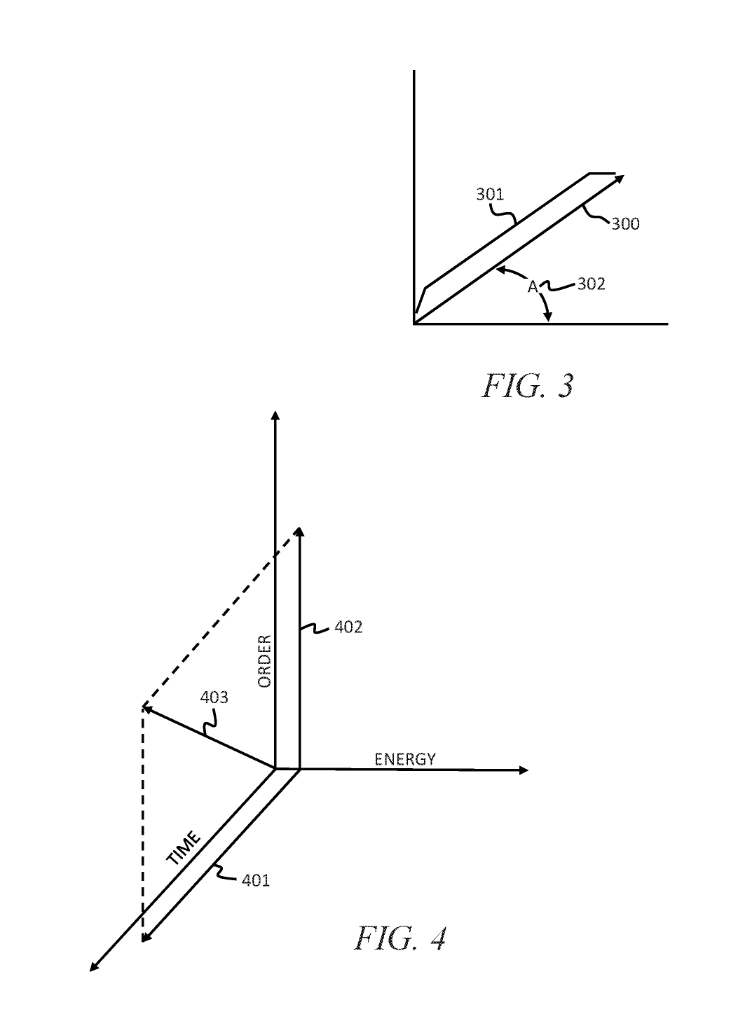

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space- time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

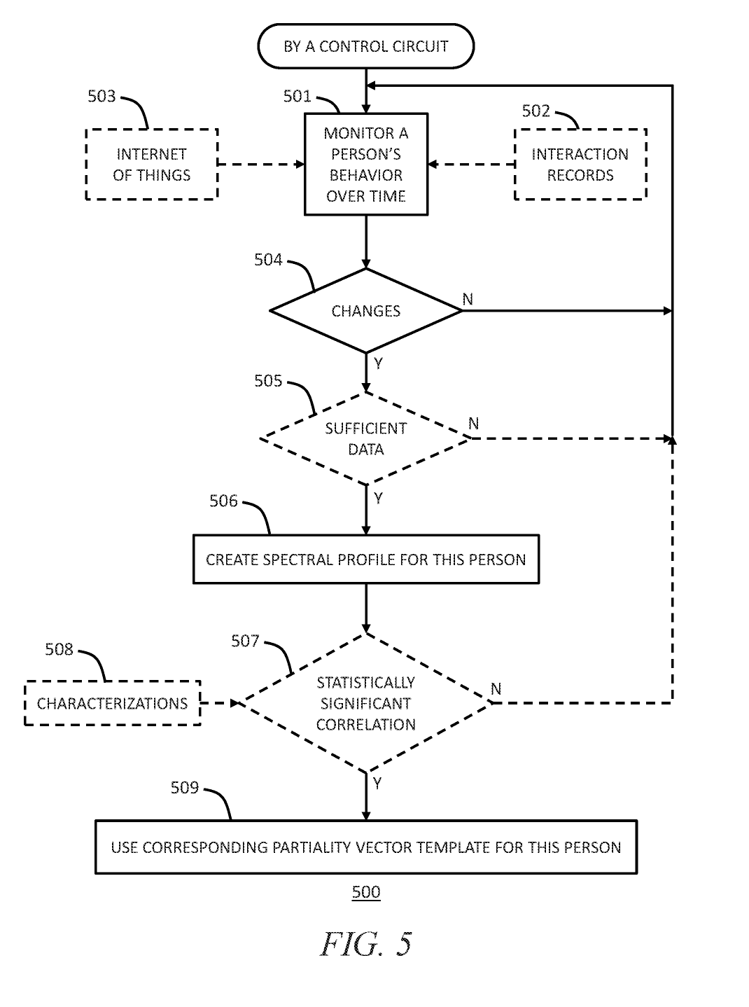

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

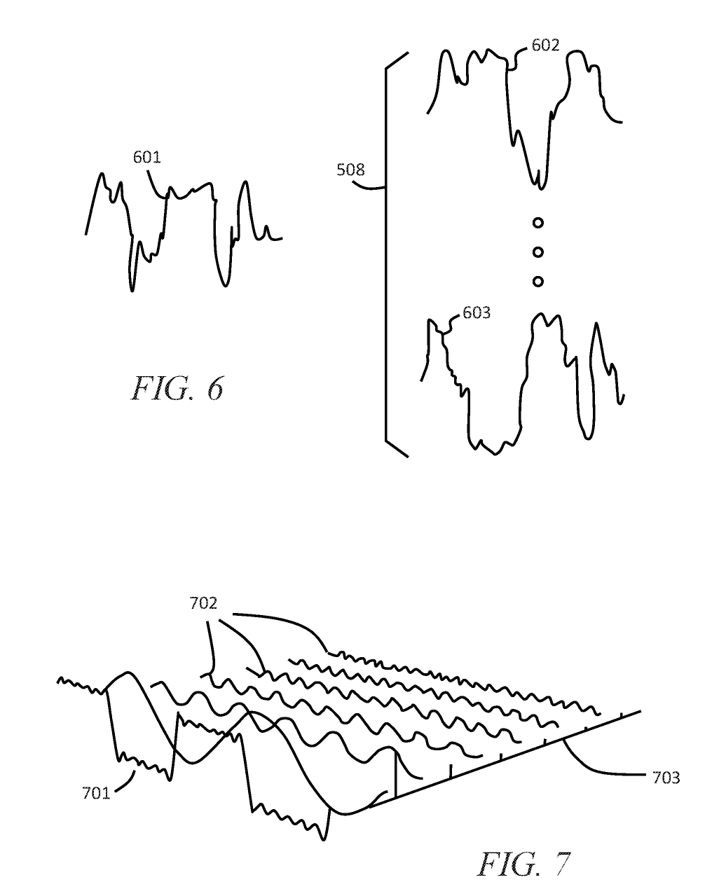

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

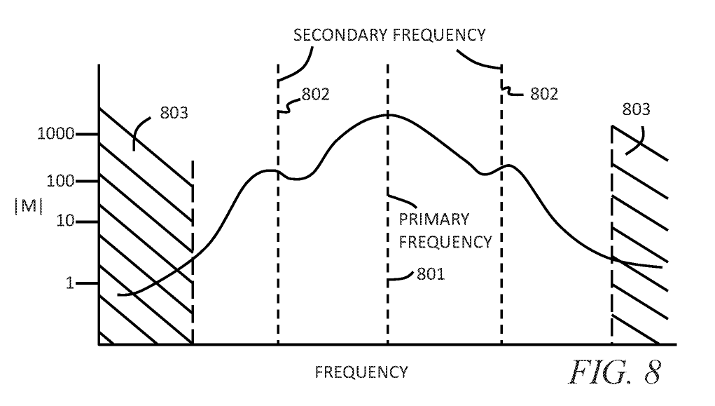

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest- frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

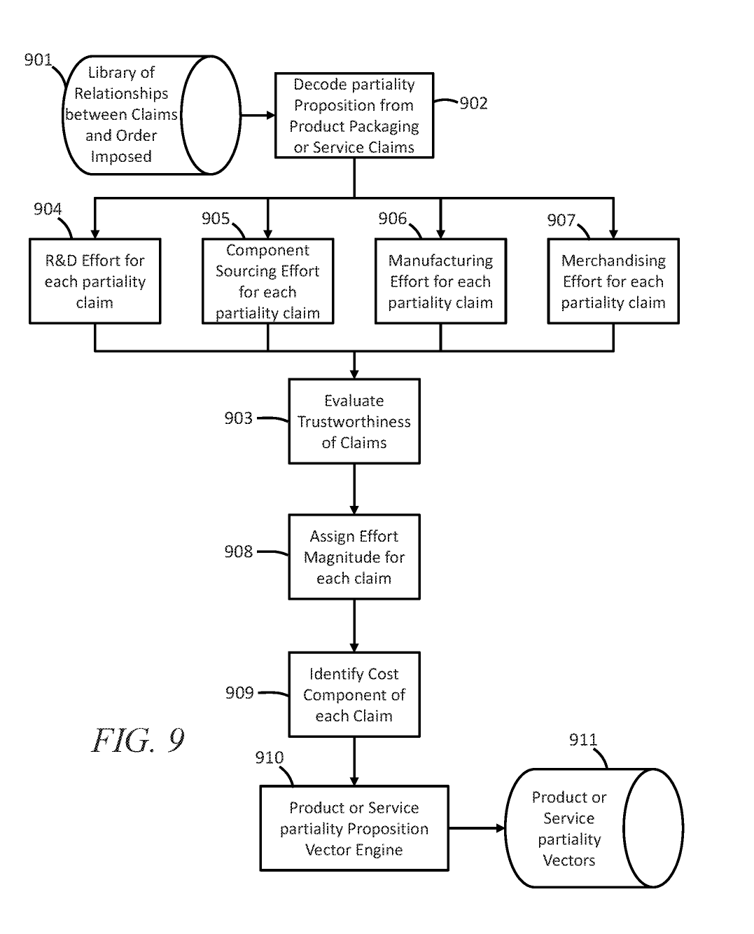

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

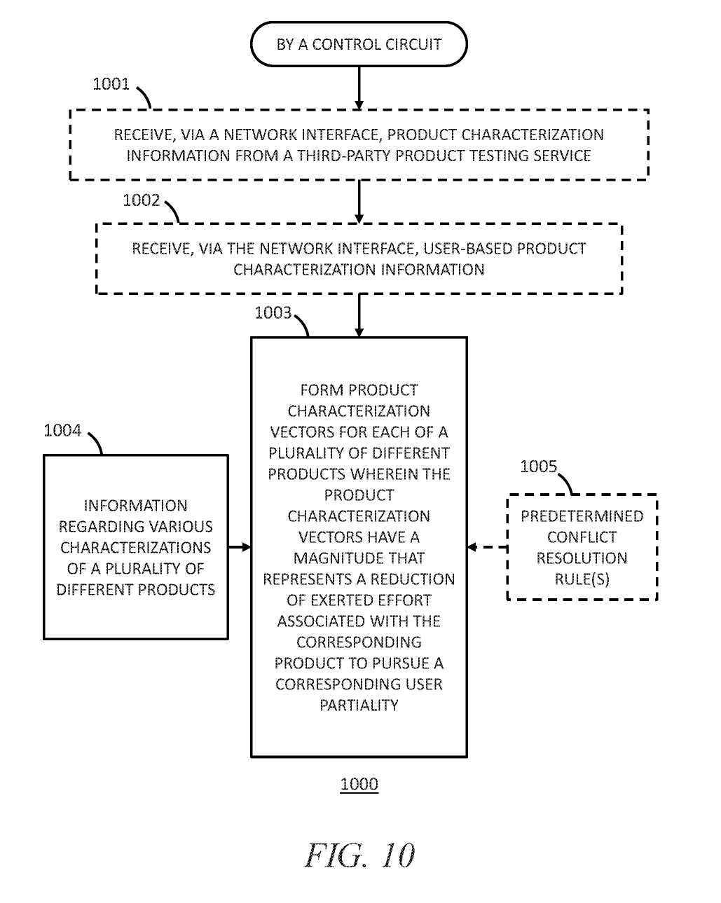

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

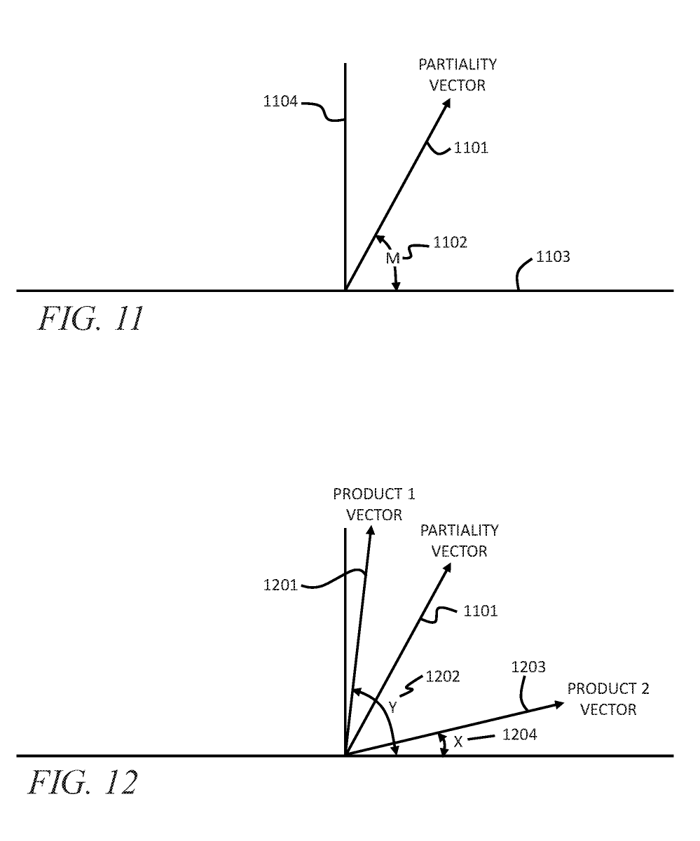

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

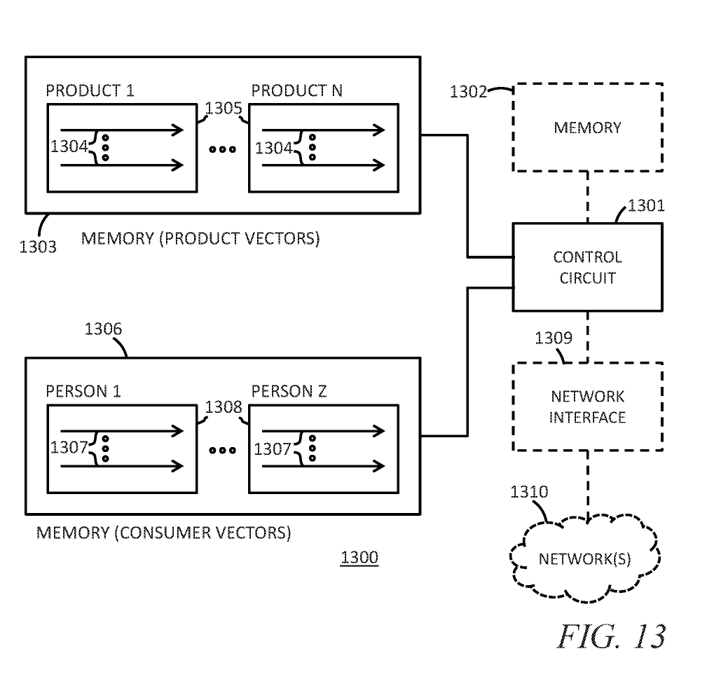

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

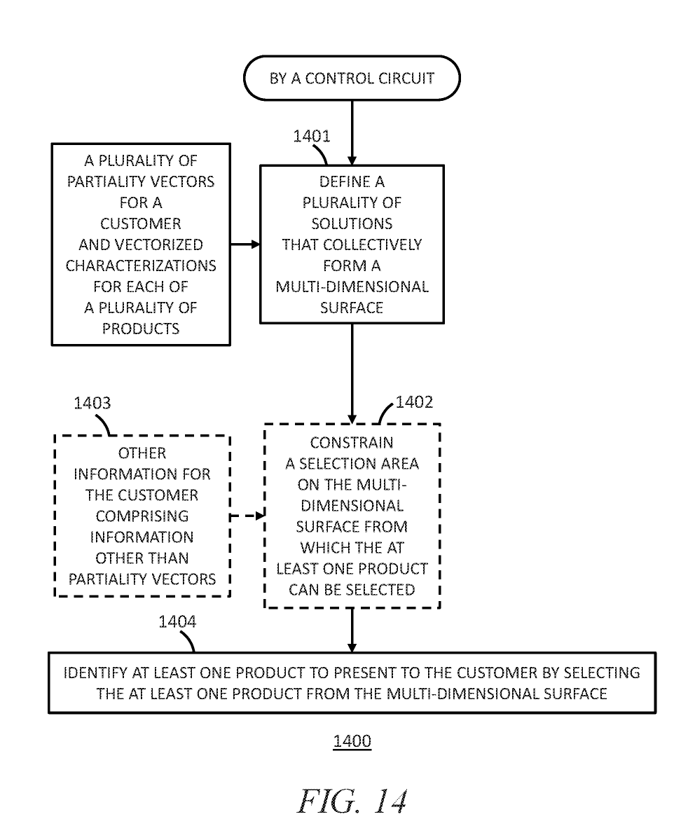

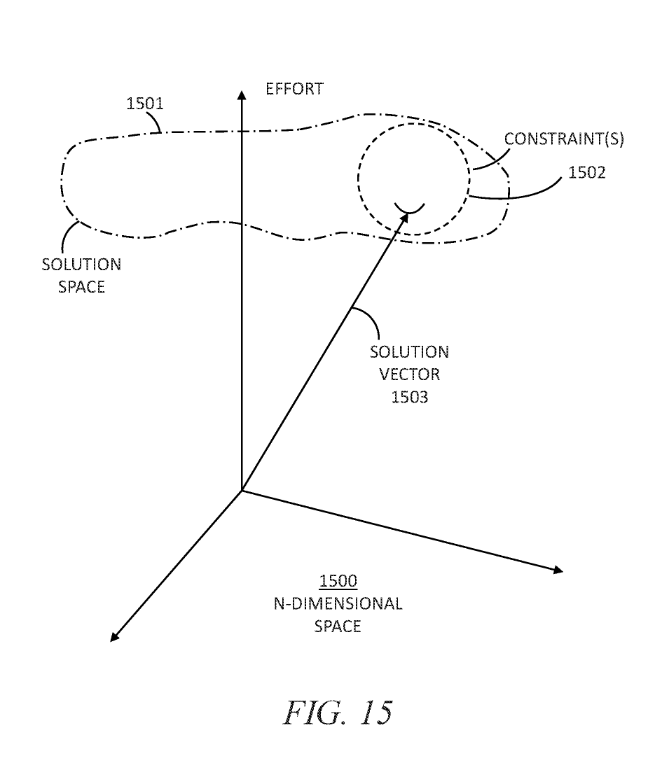

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

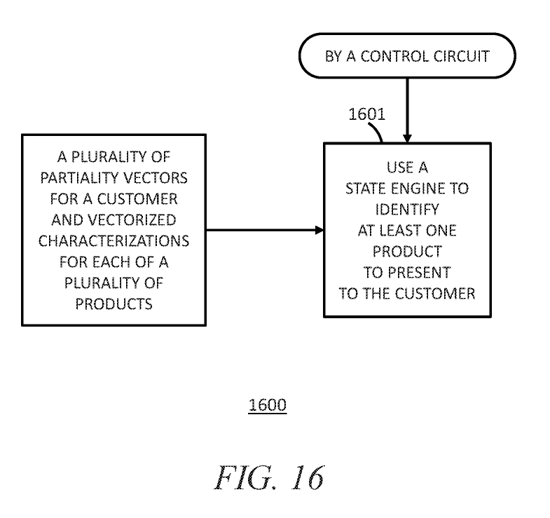

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Pursuant to various embodiments, systems, apparatuses and methods are provided that enable customers to receive expert support and advice regarding products, their uses and corresponding products. In some embodiments, a system is provided that supports customers while shopping. The system includes a plurality of virtual reality rendering systems positioned within a retail shopping facility and positioned at different locations within the retail shopping facility. The system accesses, and in some implementations maintains, a field of expertise database that associates each of multiple different products with one or more of multiple different fields of expertise, and further associates these different products with one of multiple different virtual reality environments that each correspond to one of the fields of expertise and that correspond to an environment in which the corresponding product is expected to be used. A central control system, which includes a central control circuit, is configured to identify a product for which a customer is requesting expert advice regarding how to use the product. The central control system can access the field of expertise database and obtain and/or identify at least a first field of expertise associated with the product. In some embodiments, the central control system accesses a virtual reality content database and acquire a set of code to be applied in rendering a virtual reality environment corresponding to the first field of expertise and the product. One or more sets of code are distributed to at least one rendering system, of the plurality of rendering systems, corresponding to the customer to cause the rendering system to visually render the virtual reality environment and a first expert avatar that appears as an expert in the field of expertise and that virtually illustrates at least how to correctly use the product within a physical environment represented by the virtual reality environment.

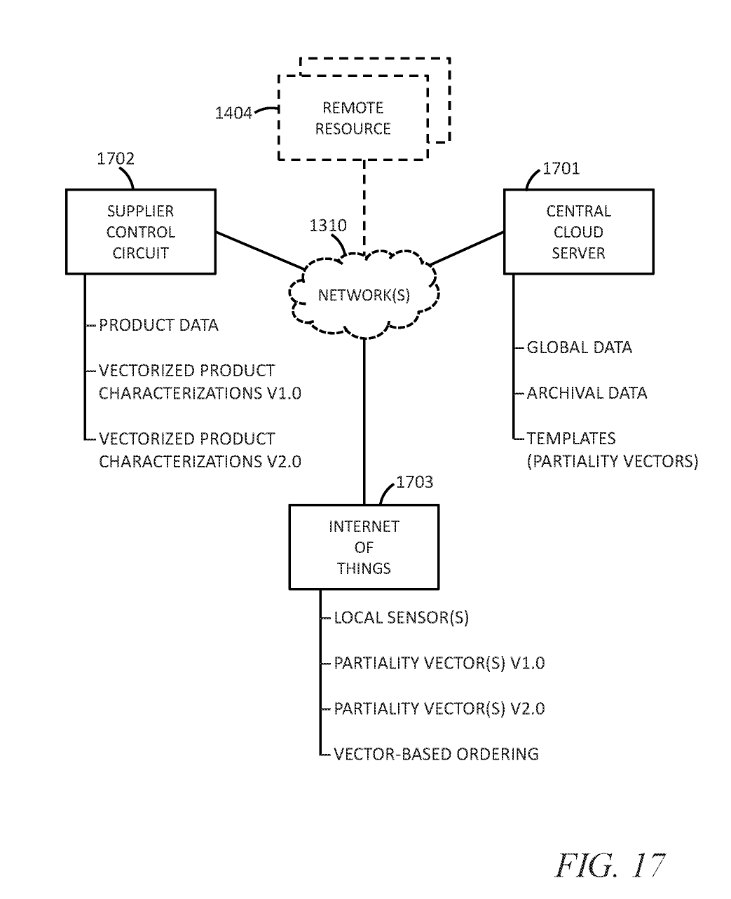

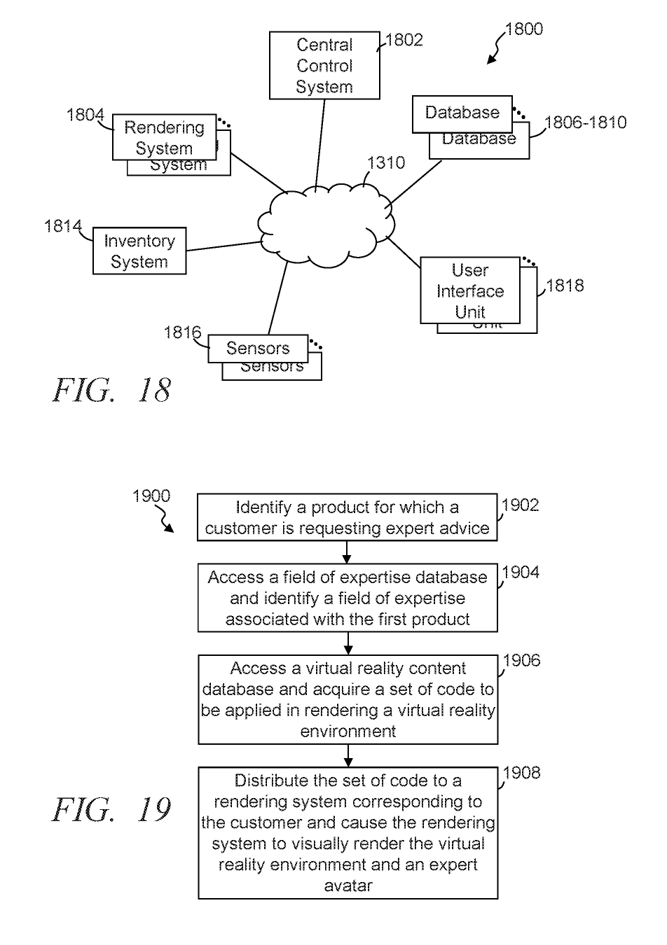

FIG. 18 illustrates a simplified block diagram of an exemplary customer service and support system 1800 that is associated with one or more retail shopping facilities, in accordance with some embodiments. The customer service system includes a customer service central control system 1802, a plurality of rendering systems 1804, and one or more databases 1806-110. The central control system 1802 is communicatively coupled with the rendering systems and databases over one or more distributed computer and/or communication networks 1310 (e.g., a local area network (LAN), the Internet, wide area network (WAN), etc.) having wired and/or wireless communication links. The system typically further includes one or more inventory systems 1814, and multiple sensors 1816 of a sensor system distributed throughout at least portions of the shopping facility. The inventory system tracks quantities of products and locations of products within the facility, including on the sales floor. In some embodiments, the inventory system couples with and/or maintains the product database 1810 that includes product identifiers for products at the shopping facility and in some instances ordered. The product database may further maintain product profiles, product partiality vectors, product characteristics and/or adjustable characteristics. In some embodiments, the product database defines associations between products, such as but not limited to products that can be used together, products on which a product of interest can be used (e.g., knife on multiple different identified food products), products that can enhance the use of another product, and the like.

In some embodiments, the system includes and/or communicates with one or more user interface units 1818 that are associated with customers and/or workers of the shopping facilities. The user interface units can be one or more of a variety of user interface units including, but not limited to, mobile and/or handheld electronic devices such as so-called smart phones and portable computers such as tablet/pad-styled computers, custom shopping facility units (e.g., scanners, two-way communication devices, etc.), and other such devices. Some or all of the user interface units may wirelessly communicate with the central control system 1802 over one or more of the computer and/or communication networks 1310 (e.g., Wi-Fi wireless network, cellular, Bluetooth, Ethernet, etc.). In some embodiments, the system utilizes one or more user interface units 1818 as at least part of a virtual reality rendering system 1804.

The customer support system 1800 provides support to customers while shopping at a shopping facility. At least in part, the system is configured to provide virtual expert customer advice to customers about products, such as but not limited to the correct use of products. The central control system 1802 is configured to identify products that customers may like expert advice and/or are for which they are requesting expert advice, such as but not limited how to use the product, when to use the product, in which environments one may use the product, other such information, and often a combination of such information. The central control system 1802 may use sensor data from the one or more sensors 1816 to identify a product that a customer is looking at, identify a product a customer has picked up, identify one or more products corresponding to a location that the customer has been at for more than a threshold period of time, and the like. In some embodiments, the system includes a series of sensors positioned and distributed in multiple locations in the shopping facility that communicate sensor information to the central control system. The central control system 1802 is communicatively coupled with the series of sensors. A product being touched or picked up by a customer can be identified based on sensor information received from at least one of the series of sensors.

The sensor information may include reading an RFID tag associated with a product that the customer picks up through one or more RFID tag readers, such as a read on a shopping cart being pushed by a customer, an RFID tag reader on a shelf unit, an RFID tag reader mounted in the ceiling, other such reader or combination of two or more readers. Similarly, sensor information may include bar code data, such as an image of a bar code on a product from fixed cameras within the shopping facility, from a camera of a user interface unit, and/or other such cameras, bar code data from a bar code reader, or other such sources. The sensor information may further include images of products, and through image processing the product may be identified. Other sensor information may be received and processed in identifying one or more products. Sensor information from multiple different types of sensors can be used and the combination of information used to identify a product.

The central control circuit accesses the field of expertise database 1806, and based on the first product identifies a first field of expertise associated with the first product. Again, the field of expertise database associates different products with one or more of multiple different fields of expertise. The fields of expertise correspond to different subjects about which a person can learn and gain knowledge, and when a person gains a sufficient level of knowledge about a field that person can provide advice and guidance to other people. Similarly, a person can learn enough about a field and have sufficient skill at providing guidance and advice about that field that others view that person as an expert in that field. For example, a person may be a chef and accordingly some people may see that person as an expert in one or more fields of cooking. Further, if the chef has a specialty in pastries, some people may see that person as an expert in a field of pastry cooking. Still further, a person may become recognized based on their level of expertise in a field. For example, a chef with a cooking show may gain some public notoriety and be recognized by a relatively large group of people as an expert in one or more fields of cooking. The field of expertise database identifies numerous different fields for which a person may be considered an expert. For example, fields may include fishing, camping, rock climbing, mountain climbing, hiking, backpacking, biking, mountain biking, travel, cooking, clothing, toys, child safety, food, jewelry, one or more sports (e.g., soccer, football, baseball, etc.), working on motors of cars, customizing cars, customizing motorcycles, and numerous other fields. Further, fields may include sub-fields and/or be divided into multiple different fields (e.g., pastry cooking, BBQ cooking, Italian cooking, etc.; fielding in baseball, pitching in baseball, batting in baseball, etc.; and other such fields). The field of expertise database associates products that can be used in and/or may be beneficial relative to one or more of multiple different fields of expertise.

In some embodiments, the field of expertise database further associates the different products with one of multiple different virtual reality environments that each correspond to one of the fields of expertise and that correspond to a physical environment in which the corresponding product is expected to be used. Different products have different uses, but are typically used by people in performing one or more tasks within one or more environments. For example, a kitchen knife is typically used by a person in a kitchen environment while cooking and preparing food. Similarly, a sleeping back may be used in a camping environment, while also may be used in a home (e.g., when guests are visiting, children's′ sleepovers, etc.). As other examples, a fishing pole is used in a lake and ocean environments, a rifle is used in hunting environments (e.g., lake for duck hunting, mountains for deer hunting, etc.), a couch is used in a home, some offices and other such environments, and a frying pan is used in a kitchen environment. Some products may be used in multiple different environments, such as a screwdriver being associated with a home improvement environment, an automotive environment, and other environments. The field of expertise database and/or an environment database associates different products with different virtual reality environments that correspond to physical environments in which the products are expected to be used. In some embodiments, the environments may be associated with one or more of the fields of expertise. The virtual reality environments are rendered through the rendering systems while providing the advice and/or other information about a product to the customer. For example, a knife may be associated with a kitchen environment, and in rendering expert advice a virtual kitchen environment is rendered as a background in which the virtual expert is positioned when providing the expert advice, such as demonstrating how to properly use the knife, food products on which the knife is intended to be used and/or that the knife is particularly suited, how to properly hold the knife, how to properly care for the knife, and the like.

The expert advice can include general advice such as but not limited type of product particularly effective with some types of activates, benefits of a product, differences of a product relative to one or more other products, and other similar general advice. Further, the expert advice can provide ratings information, such as ratings from customers, ratings from other professionals in one or more relevant fields of use, and/or other such ratings. The expert advice can additionally include advice that is more specific and dependent on a level of expertise and knowledge about a product and one or more fields of expertise and use. For example, the expert advice can provide detailed information about how a product is used, a correct way to use a product, an incorrect way to use a product, incorrect general assumptions often associated with a product or its use, alternative uses of a product, alternative products to use for an activity, and other such expert advice. The expert advice may include highly specific advice, such as precise positioning of fingers when holding and/or using a product to perform a specific activity, an orientation of a person's hand relative to an object on which the product is being used, variations on use, problems that may be experienced and how to overcome those problems, and other such expert advice. The level of advice may further be adjusted based on knowledge of a customer and/or a determined level of knowledge of the customer. For example, the central control system 1802 may access information about the customer indicating the customer regularly cooks, has obtained some instruction in cooking, or other levels of cooking, and can modify the type, quantity and/or level of expert advice to be consistent with a determined level of the customer's expertise in the corresponding field of expertise. Further, the expert advice is presented to the customer with a degree of professionalism to emphasize the reliability of the expert advice. This expert advice information can be accumulated over time from a product manufacturer, input from actual experts, feedback from experts regarding their experiences using a product, research into a manufacturer's claims regarding a product, testing of products, and other such sources.

The central control system 1802 can, in some embodiments, select a virtual reality environment based on the product selected. Further, when a product is associated with multiple environments, the control system can take into consideration one or more other factors in selecting the environment, such as where the customer is located in the shopping facility when expert advice is to be provided, other products the customer has considered, other products the customer as selected for purchase, customer's history of purchases, customer's partiality vectors, other such factors, or a combination of two or more of such factors. A virtual expert can be associated with a virtual reality environment and/or a virtual expert can be selected based in part on an identified virtual reality environment in which the central control system 1802 is going to present the expert advice.

In some embodiments, the central control system 1802 accesses a virtual reality content database 1807 and acquires one or more sets of code to be applied in rendering a virtual reality environment corresponding to the field of expertise and the first product. Similarly, the central control system 1802 can access one or more sets of code to be applied in cooperatively rendering the virtual expert avatar and the virtual product being used by the expert avatar when providing the expert advice, and typically within the virtual environment.

The identified and accessed one or more sets of code can be distributed to one or more rendering systems 1804 of the plurality of rendering systems corresponding to the customer. In some embodiments, the one or more rendering systems may comprise rendering processing systems and separate display systems. The rendering processing systems may be implemented as part of the central control system 1802 or may be a separate processing system. In some embodiments, the implementation of the code causes the rendering systems generate visual and/or audio content to render on one or more display systems, which are distributed throughout the shopping facility, the virtual reality environment and the expert avatar providing expert advice relative to one or more products, and often renders the one or more product being used by the expert avatar. Additionally or alternatively, some or all of the accessed one or more sets of code can be implemented by the central control system 1802 to generate visual and/or audio content that is distributed to one or more display systems. The central control system 1802 causes the first rendering system to visually and/or audibly render the virtual reality environment and an expert avatar that appears as an expert in the field of expertise and that virtually provides expert advice, such as but not limited to illustrating at least how to correctly use the product within a physical environment represented by the virtual reality environment, what other products can be used with the product of interest and/or other products the product of interest is intended to be used with, how to properly hold the product of interest, when to use the product of interest, other uses of the product of interest, other products that can enhance the use of the product of interest, characteristics of the product of interest, benefits of the product of interest, drawbacks of a product of interest, recommended alternative products, rating of a product of interest, other information, and often a combination of two or more of such information. For example, an expert avatar in a field of hunting can show and explain how to load a rifle, show and explain how to hold the rifle, show and explain different types of ammunition to use with the rifle depending on animals being hunted (and where to find the ammunition in the shopping facility or another retailer), how to clean and care for the rifle, identify other products that may be of interest (e.g., a case for the rifle and where to find the case in the shopping facility or other retailer, cleaning kit, carry straps, and the like), and in some instances information about other products that may have a relation to hunting and/or the customer (e.g., camping gear, easily portable food products, hunting clothing, cold weather clothing, etc.).

In some embodiments, the central control system 1802 enables customer to cause modifications within the virtual environment by presenting questions, interacting with a touch screen, performing hand jesters, and other such interactions. For example, a customer can modify an orientation of a rendered product. The central control system 1802 can receive and/or detect input from the customer, typically while the customer is in the shopping facility and viewing the rendered expert avatar depicted within the virtual reality environment. The input from the customer can correspond to a desired modification of a visual orientation of the product relative to its virtual use by the expert avatar. For example, the customer may rotate her/his hand and one or more sensors may detect the rotation and cause the avatar expert to similarly rotate the product (e.g., to show from a different angle how the avatar expert is holding a product). As another example, the customer may touch a touch screen display on a predefined menu option or through one or more predefined touch patterns to cause a modification of the product orientation, a modification of an orientation of the virtual environment, a modification of an orientation of the avatar expert, and/or other such modifications. Based on the received input, the control circuit can identify and cause one or more sets of code to be implemented and/or distributed to the one or more rendering systems to cause a modification to the customer's visual orientation relative to the rendered product and the expert avatar.

An expert database 1808 identifies multiple publically known experts and further associates one or more fields of expertise with each of the experts for which each of the experts is publically considered to be an expert. For example, one or more publically known chefs from one or more cooking shows and/or books could be associated with one or more cooking fields based in part on being a famous chef. As such, the expert database maintains a listing of publically know experts that are publically known for having an expertise in one or more fields. The central control system 1802 can select, from the expert database, an expert that is generally considered by the general public to be an expert in a field of expertise based in part on the product the customer is interested in and/or for which the system is providing advice. In some embodiments, the central control circuit selects the public expert on which the avatar is to be based in accordance with customer preferences, partiality vectors, historical interaction with the system, input from the customer, knowledge regarding a customer's television viewing habits, and/or other relevant information. Additionally or alternatively, the system may allow a customer to select an expert avatar and/or select a person on which the expert avatar is to be based (e.g., provide a listing of chefs and allow a customer to select one of those chefs). When rendering of the avatar, the central control system 1802 can cause the rendering of the avatar to appear as the publically known expert, and may further present the avatar with mannerisms, speech, phrases and the like similar to those of the publicly known expert.

Some embodiments use partiality vectors to identify a virtual field of expertise, products that a customer might be interested in and that correspond to a product for which the system in providing the customer with expert advice, identify a publically known expert on which to base an avatar, other such decisions, or combinations of such decisions. In some implementations, one or more customer databases 1809 can be accessed and/or maintained, and that includes an identifier for each of multiple customers, and for each customer associates customer partiality vectors with the customer. The customer partiality vectors are directed quantities that each have both a magnitude and a direction, with the direction representing a determined order imposed upon material space-time by a particular partiality and the magnitude represents a determined magnitude of a strength of the belief, by the customer, in a benefit that comes from that imposed order. The customer database may include customer profiles and/or otherwise associate other parameters with a customer, such as but not limited to purchase history, product preferences, methods of payment, previous expert advice provided, previous avatars used in providing expert advice, feedback parameters based on customer's action in relation to expert advice provided (e.g., whether the customer purchased a product for which expert advice was provided, whether the customer purchased one or more other products that was associated with the product of interest when providing expert advice, not purchasing a product, other products considered prior to and after receiving expert advice, duration of time between receiving the expert advice and making a purchase, other such parameters), family members information, activities in which the customer and/or family members participate (e.g., sports, exercise, travel, types of vacations, etc.), other parameters, and typically a combination of two or more of such parameters. The central control system, in some applications, can use the partiality vectors and/or other customer parameters to identify the field of expertise, a publicly known person on which to base an avatar, and other such selections. For example, the central control system 1802 can identify a field of expertise based on one or more partiality vectors defined for a customer. Additionally or alternatively, the central control system 1802 can further identify, based on the partiality vectors associated with a customer, adjustable characteristics corresponding to one or more products and consistent with the partiality vectors that can be used in part when rendering expert advice, so that the set of code can be distributed as defined in part by the adjustable characteristics and to cause the visually rendering of the product consistent with the adjustable characteristics. Such adjustable characteristics can include color, size, quantity, gender relation, graphics, and other such characteristics. As such, when rendering the expert advice, the product of interest and/or associated products can be rendered in a way that is consistent with the customer's partiality vectors emphasizing characteristics that are valuable to the customer (e.g., ease of use, effectiveness, etc.), as well as rendering the product consistent with how the customer is likely going to want to product.

As described above, in some embodiments the central control circuit in distributing the set of code causes the rendering of how components of a product operate together and based on the intended use of the product illustrates how that product is used with other products, and/or recommends other products to be used with the product of interest. In some applications, the central control circuit can cause the virtual rendering of one or more other products in use with the product of interest and within the virtual reality environment. For example, when the product of interest is a knife, the central control system 1802 can cause the rendering to illustrate products that can be used with the knife, showing other product being cut by the knife and how to accurately use the knife when cutting those products.

In some embodiments, the central control system 1802 communicatively couples with a series of sensors and further uses sensor information to determine a location of a customer, track a customer's progress through the shopping facility, identify the customer and/or other such actions. The series of sensors can include sensors positioned and distributed in multiple locations in the shopping facility that communicate sensor information to the central control system. The central control system 1802 can identify a customer, such as through facial recognition, RFID tag of a customer tag carried by the customer, detect a customer's user interface unit 1818 (e.g., through Wi-Fi), and/or other such sensor information. The customer's location within the shopping facility can be identified based on the sensor data. The central control system 1802 can further identify, based on the location within the shopping facility and products located proximate the location, a virtual reality environment and/or a field of expertise that is to be rendered to the first customer.

In some embodiments, the location of the customer can further be used to identify one or more rendering systems to use in rendering the expert advice to the customer. The central control system 1802 typically knows where fixed rendering systems are located within the shopping facility and may track the movement of other rendering systems (e.g., rendering systems secured with a shopping cart, customers' user interface units 1818, and other such rendering systems). With knowledge of the location of the customer, the central control system 1802 can direct one or more of the rendering systems that are within one or more threshold distances of the customer to be activated to cause the rendering of the virtual reality environment, the avatar and when relevant the virtual product. The threshold distance can vary depending on one or more factors such as but not limited to proximity of other customers, whether the system is using the customers user interface unit as part of a rendering system, a customer's orientation relative to the rendering system, levels of ambient noise, whether the customer is accompanied by other customers or individuals (e.g., children), and other such factors.

The customer support system 1800 can provide customer with access to expert advice while the customers shop in the shopping facilities. In some embodiments, the system further provides customers to access expert advice while outside the shopping facility. A customer can access an ordering system (e.g., through a web interface of an Internet site) to browse products and/or request expert advice. Similarly, in some embodiments the customers can access previously accessed expert advice to re-watch the expert advice and/or link to other related advice and/or information.

In some embodiments, the central control circuit can track expert advice and/or other information provided to a customer regarding a product. This information can be maintained to allow a customer to readily re-access the same or similar information at a future time. For example, the central control circuit can cause one or more expert advice identifiers to be associated with a customer identifier (e.g., in a customer's user profile). Upon accessing a customer account, for example through a graphical user interface displayed through a user interface unit (e.g., computer, smartphone, tablet, etc.), one or more options may be provided to allow a customer to access previous expert advice, a historical listing of expert advice previously accessed, a listing of products for which expert advice was provided, links to related expert advice (e.g., other uses expert advice, alternative products expert advice, etc.) and/or other such options that allow a customer to access previously accesses expert advice and in some instances other related expert advice.

FIG. 19 illustrates a simplified flow diagram of an exemplary process 1900 of supporting customers while shopping and providing customers with expert advice, in accordance with some embodiments. In step 1902, a product is identified for which a customer is requesting expert advice on how to use a product. This identification can be based on sensor information, information provided by a customer (e.g., through a user interface unit and/or a rendering system the customer can identify a product). In step 1904, a field of expertise database is accessed, and a field of expertise is identified that is associated with the product. Again, the field of expertise database associates each of multiple products with one or more of multiple different fields of expertise and with one of multiple different virtual reality environments each corresponding to one of the fields of expertise and that correspond to an environment in which the product is expected to be used.

In step 1906, a virtual reality content database is accessed and from which is identified and/or acquired one or more sets of code to be applied in rendering a virtual reality environment corresponding to the field of expertise and the product. This code and/or other code can include for example code regarding the rendering of the virtual reality environment, an expert avatar, an avatar of the product, an avatar of other products, other such information, and often a combination of such code. In step 1908, the one or more sets of code can be distributed to one or more rendering systems, of the plurality of rendering systems positioned within a retail shopping facility (e.g., fixed display systems, mobile rendering systems, customers' user interface units, etc.) and corresponding to the customer, and cause the selected one or more rendering systems to visually and/or audibly render the virtual reality environment and an expert avatar that appears as an expert in the field of expertise and that provides expert advice. In some embodiments, the expert advice can include virtually illustrating at least how to correctly use the product within a physical environment represented by the virtual reality environment.

Some embodiments receive, while the customer is in the shopping facility and viewing the rendered expert avatar depicted within the virtual reality environment, input from the customer corresponding to a desired modification of a visual orientation of the product and/or avatar relative to the products virtual use by the expert avatar. Based on the received modification information, a second set of code can be caused to be distributed to the rendering system to cause a modification to the customer's visual orientation relative to the rendered product and the expert avatar. In selecting the expect, from an expert database identifying multiple publically known experts and associating one or more fields of expertise with each of the experts for which each of the experts is publically considered to be an expert, some embodiments select the expert with the first expert being identified in the expert database as generally considered by the general public to be an expert in the field of expertise. In rendering of the avatar the system can cause the rendering of the avatar to appear as one of the publically known experts.

In some embodiments, sensor data is received from at least one sensor of a series of sensors positioned and distributed in multiple locations in the shopping facility. The product may be identifying as a product being touched by the customer based on the sensor information received from the at least one sensor of the series of sensors. Customers can be identified, and a customer database can be accessed. The customer database, in some implementations can include an identifier for each of multiple customers, and for each customer associates customer partiality vectors with the customer. The field of expertise can be identified based on a partiality vector defined for a particular customer. Some embodiments identify, based on the partiality vectors associated with a customer, adjustable characteristics corresponding to a product and consistent with the partiality vectors. In distributed the set of code can comprise code as defined in part by the adjustable characteristics, while causing the visually rendering of the product consistent with the adjustable characteristics.

The system can further be configured to identify other products to be recommended for used with the product of interest and for which advice is to be provided. In distributing the set of code, some embodiments distribute the set of code causing the rendering of how components of the product operate together and based on the intended use of the product further cause a virtual rendering of at least one of the other products in use with the product within the virtual reality environment. In some embodiments, sensor information is received from at least one sensor of a series of sensors positioned and distributed in multiple locations in the shopping facility. A customer can be identified, and a location within the shopping facility of the first customer can be identified based on the sensor data. Based on the location within the shopping facility and products located proximate the location, a virtual reality environment and a field of expertise can be identified that is to be rendered to the customer.

Some embodiments provide systems to support customers while shopping, comprising: a plurality of virtual reality rendering systems positioned within a retail shopping facility; a field of expertise database associating each of multiple products with one or more of multiple different fields of expertise and with one of multiple different virtual reality environments each corresponding to one of the fields of expertise and that correspond to an environment in which the product is expected to be used; a central control system comprising a central control circuit coupled with memory storing code that when implemented causes the central control circuit to: identify a first product for which a first customer is requesting expert advice on how to use the first product; access the field of expertise database and identify a first field of expertise associated with the first product; access a virtual reality content database and acquire a first set of code to be applied in rendering a first virtual reality environment corresponding to the first field of expertise and the first product; and distribute the first set of code to a first rendering system of the plurality of rendering systems corresponding to the first customer to cause the first rendering system to visually render the first virtual reality environment and a first expert avatar that appears as an expert in the first field of expertise and that virtually illustrates at least how to correctly use the first product within a physical environment represented by the first virtual reality environment.

In some implementations, the central control circuit is further configured to: receive, while the customer is in the shopping facility and viewing the rendered first expert avatar depicted within the first virtual reality environment, input from the first customer corresponding to a desired modification of a visual orientation of the first product relative to its virtual use by the first expert avatar; and cause a second set of code to be distributed to the first rendering system to cause a modification to the first customer's visual orientation relative to the rendered first product and the first expert avatar. The system may further comprise: an expert database identifying multiple publically known experts and associating one or more fields of expertise with each of the experts for which each of the experts is publically considered to be an expert; and wherein the central control circuit is configured to select, from the expert database, the first expert that is generally considered by the general public to be an expert in the first field of expertise, and in the causing of the rendering of the avatar causes the rendering of the avatar to appear as the first publically known expert. In some embodiments, the system further comprises: a series of sensors positioned and distributed in multiple locations in the shopping facility that communicate sensor information to the central control system; wherein the central control system is communicatively coupled with the series of sensors, and in identifying the first product, is further configured to identify the first product being touched by the first customer based on sensor information received from at least one of the series of sensors.

Additionally, some embodiments further comprise: a customer database comprising an identifier for each of multiple customers, and for each customer associates customer partiality vectors with the customer, wherein the customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order; wherein the central control system in identifying the first field of expertise further identifies the first field of expertise based on a partiality vector defined for the first customer. The central control system may further be configured to identify, based on the partiality vectors associated with the first customer, adjustable characteristics corresponding to the first product and consistent with the partiality vectors wherein the distribution of the first set of code comprises distributing the first set of code as defined in part by the adjustable characteristics and to cause the visually rendering of the first product consistent with the adjustable characteristics. In some instances, the central control circuit in distributing the first set of code is configured to cause the rendering of how components of the first product operate together and based on the intended use of the first product further recommend other products to be used with the first product and further cause a virtual rendering of at least one of the other products in use with the first product within the first virtual reality environment.

In some embodiments, the system further comprises: a series of sensors positioned and distributed in multiple locations in the shopping facility that communicate sensor information to the central control system; wherein the central control system is communicatively coupled with the series of sensors and configured to: receive the sensor information; identify the first customer; identify a location within the shopping facility of the first customer based on the sensor information; and identify, based on the location within the shopping facility and products located proximate the location, the first virtual reality environment and the first field of expertise that is to be rendered to the first customer.

Further, some embodiments provide methods of supporting customers while shopping, comprising: by a central control circuit of a shopping facility: identifying a first product for which a first customer is requesting expert advice on how to use a first product; accessing a field of expertise database and identifying a first field of expertise associated with the first product, wherein the field of expertise database associates each of multiple products with one or more of multiple different fields of expertise and with one of multiple different virtual reality environments each corresponding to one of the fields of expertise and that correspond to an environment in which the product is expected to be used; accessing a virtual reality content database and acquiring a first set of code to be applied in rendering a first virtual reality environment corresponding to the first field of expertise and the first product; and distributing the first set of code to a first rendering system, of a plurality of rendering systems positioned within a retail shopping facility, corresponding to the first customer and causing the first rendering system to visually render the first virtual reality environment and a first expert avatar that appears as an expert in the first field of expertise and that virtually illustrates at least how to correctly use the first product within a physical environment represented by the first virtual reality environment. The method may further comprise: receiving, while the customer is in the shopping facility and viewing the rendered first expert avatar depicted within the first virtual reality environment, input from the first customer corresponding to a desired modification of a visual orientation of the first product relative to its virtual use by the first expert avatar; and causing a second set of code to be distributed to the first rendering system to cause a modification to the first customer's visual orientation relative to the rendered first product and the first expert avatar.

In some applications, a method may further comprise: selecting the first expect, from an expert database identifying multiple publically known experts and associating one or more fields of expertise with each of the experts for which each of the experts is publically considered to be an expert, wherein the first expert is identified in the expert database as generally considered by the general public to be an expert in the first field of expertise; and wherein the causing the rendering of the avatar comprises causing the rendering of the avatar to appear as the first publically known expert. The method, in some applications, further comprises: receiving sensor information from at least one sensor of a series of sensors positioned and distributed in multiple locations in the shopping facility; wherein the identifying the first product further comprises identifying the first product being touched by the first customer based on the sensor information received from the at least one sensor of the series of sensors. Some embodiments further: identify the first customer; and access a customer database comprising an identifier for each of multiple customers, and for each customer associates customer partiality vectors with the customer, wherein the customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order; wherein the identifying the first field of expertise further comprises identifying the first field of expertise based on a partiality vector defined for the first customer.

In some embodiments, one or more methods comprise: identifying, based on the partiality vectors associated with the first customer, adjustable characteristics corresponding to the first product and consistent with the partiality vectors; wherein the distributing of the first set of code comprises distributing the first set of code as defined in part by the adjustable characteristics and causing the visually rendering of the first product consistent with the adjustable characteristics. Some embodiments further comprise: identifying other products to be recommended for used with the first product; and wherein the distributing the first set of code comprises distributing the first set of code causing the rendering of how components of the first product operate together and based on the intended use of the first product further causes a virtual rendering of at least one of the other products in use with the first product within the first virtual reality environment. One or more methods may further comprise: receiving sensor information from at least one sensor of a series of sensors positioned and distributed in multiple locations in the shopping facility; identifying the first customer; identifying a location within the shopping facility of the first customer based on the sensor information; and identifying, based on the location within the shopping facility and products located proximate the location, the first virtual reality environment and the first field of expertise that is to be rendered to the first customer.

Pursuant to various embodiments, systems, apparatuses and methods are provided that enable customers to receive expert support and advice regarding products, their uses and corresponding products. In some embodiments, a system is provided that supports customers while shopping. The system includes a plurality of virtual reality rendering systems positioned within a retail shopping facility and positioned at different locations within the retail shopping facility. The system accesses, and in some implementations maintains, a field of expertise database that associates each of multiple different products with one or more of multiple different fields of expertise, and further associates these different products with one of multiple different virtual reality environments that each correspond to one of the fields of expertise and that correspond to an environment in which the corresponding product is expected to be used. A central control system, which includes a central control circuit, is configured to identify a product for which a customer is requesting expert advice regarding how to use the product. The central control system can access the field of expertise database and obtain and/or identify at least a first field of expertise associated with the product. In some embodiments, the central control system accesses a virtual reality content database and acquire a set of code to be applied in rendering a virtual reality environment corresponding to the first field of expertise and the product. One or more sets of code are distributed to at least one rendering system, of the plurality of rendering systems, corresponding to the customer to cause the rendering system to visually render the virtual reality environment and a first expert avatar that appears as an expert in the field of expertise and that virtually illustrates at least how to correctly use the product within a physical environment represented by the virtual reality environment.

In some embodiments, provide a customization of a rendered virtual avatar that can be specific to a customer and that has characteristics that the customer desires and/or prefers. In some applications, a central control system can access a customization database associating each of multiple fields of expertise with a respective set of one or more avatar characteristics. Based on the identified field of expertise, one or more sets of avatar characteristics can be identified that correspond to the customer and the field of expertise. The set of avatar characteristics are configured to be applied in customizing for the customer a rendered customized avatar within a virtual reality environment corresponding to the field of expertise, and in some instances a product of interest.

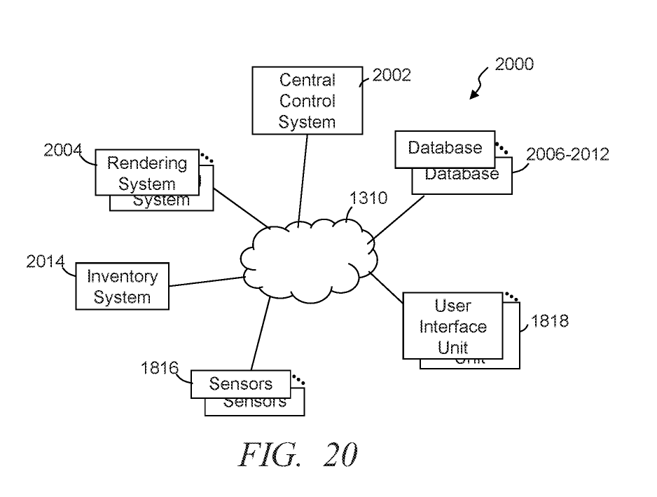

FIG. 20 illustrates a simplified block diagram of an exemplary customer service and support system 2000 that is associated with one or more retail shopping facilities, in accordance with some embodiments. The customer service system includes a customer support central control system 2002, a plurality of rendering systems 2004, and one or more databases 2006-2012. The central control system 2002 is communicatively coupled with the rendering systems and databases over one or more distributed computer and/or communication networks 1310 (e.g., a local area network (LAN), the Internet, wide area network (WAN), etc.) having wired and/or wireless communication links. The system typically further includes one or more inventory systems 2014, and multiple sensors 1816 of a sensor system distributed throughout at least portions of the shopping facility. The inventory system tracks quantities of products and locations of products within the facility, including on the sales floor. In some embodiments, the inventory system couples with and/or maintains the product database 2010 that includes product identifiers for products at the shopping facility and in some instances ordered. The product database may further maintain product profiles, product partiality vectors, product characteristics and/or adjustable characteristics. In some embodiments, the product database defines associations between products, such as but not limited to products that can be used together, products on which a product of interest can be used (e.g., knife on multiple different identified food products), products that can enhance the use of another product, and the like.

Some embodiments further include an expertise database 2011 that identifies multiple different products for which customer assistance is available, and for each of the multiple different products identifies and/or associates a sub-set of a set of code corresponding with one of the multiple different products and at least one of the fields of expertise. The sub-set of code defines one or more types of expertise regarding the use of the corresponding product and other products to be used with the corresponding product. Further, some embodiments include a customization database 2012 that at least in part associates each of the fields of expertise with a respective set of one or more avatar characteristics. The avatar characteristics are configured to be applied in rendering a customized avatar. In some applications, at least some avatar characteristics may be associated with a customer and can be used by the central control system 2002 in customizing the rendered avatar so that the avatar includes features (e.g., appearance, speech patterns, accents, language, when to be rendered, with relation to one or more products, and other such characteristics and features) preferred and/or requested by a specific customer.

In some embodiments, the system includes and/or communicates with one or more user interface units 1818 that are associated with customers and/or workers of the shopping facilities. Again, the user interface units can be one or more of a variety of user interface units including, but not limited to, mobile and/or handheld electronic devices such as so-called smart phones and portable computers such as tablet/pad-styled computers, custom shopping facility units (e.g., scanners, two-way communication devices, etc.), and other such devices. Some or all of the user interface units may wirelessly communicate with the central control system 2002 over one or more of the computer and/or communication networks 1310 (e.g., Wi-Fi wireless network, cellular, Bluetooth, Ethernet, etc.). In some embodiments, the system utilizes one or more user interface units 1818 as at least part of a virtual reality rendering system 2004.

The customer support system 2000 provides support to customers while shopping at a shopping facility. At least in part, the system is configured to provide virtual expert customer advice to customers about products, such as but not limited to the correct use of products. The central control system 2002 is configured to identify products that customers may like expert advice and/or are for which they are requesting expert advice, such as but not limited how to use the product, when to use the product, in which environments one may use the product, other such information, and often a combination of such information. The central control system 2002 may use sensor data from the one or more sensors 1816 to identify a product that a customer is looking at, identify a product a customer has picked up, identify one or more products corresponding to a location that the customer has been at for more than a threshold period of time, and the like. In some embodiments, the system includes a series of sensors positioned and distributed in multiple locations in the shopping facility that communicate sensor information to the central control system. The central control system 2002 is communicatively coupled with the series of sensors. A product being touched or picked up by a customer can be identified based on sensor information received from at least one of the series of sensors.

Again, the sensor information may include reading an RFID tag associated with a product that the customer picks up through one or more RFID tag readers, such as a read on a shopping cart being pushed by a customer, an RFID tag reader on a shelf unit, an RFID tag reader mounted in the ceiling, other such reader or combination of two or more readers. Similarly, sensor information may include bar code data, such as an image of a bar code on a product from fixed cameras within the shopping facility, from a camera of a user interface unit, and/or other such cameras, bar code data from a bar code reader, or other such sources. The sensor information may further include images of products, and through image processing the product may be identified. Other sensor information may be received and processed in identifying one or more products. Sensor information from multiple different types of sensors can be used and the combination of information used to identify a product.

The central control circuit accesses the field of expertise database 2006, and based on the first product identifies a first field of expertise associated with the first product. Again, the field of expertise database associates different products with one or more of multiple different fields of expertise. The fields of expertise correspond to different subjects about which a person can learn and gain knowledge, and when a person gains a sufficient level of knowledge about a field that person can provide advice and guidance to other people. Similarly, a person can learn enough about a field and have sufficient skill at providing guidance and advice about that field that others view that person as an expert in that field. For example, a person may be a chef and accordingly some people may see that person as an expert in one or more fields of cooking. Further, if the chef has a specialty in pastries, some people may see that person as an expert in a field of pastry cooking. Still further, a person may become recognized based on their level of expertise in a field. For example, a chef with a cooking show may gain some public notoriety and be recognized by a relatively large group of people as an expert in one or more fields of cooking. The field of expertise database identifies numerous different fields for which a person may be considered an expert. For example, fields may include fishing, camping, rock climbing, mountain climbing, hiking, backpacking, biking, mountain biking, travel, cooking, clothing, toys, child safety, food, jewelry, one or more sports (e.g., soccer, football, baseball, etc.), working on motors of cars, customizing cars, customizing motorcycles, and numerous other fields. Further, fields may include sub-fields and/or be divided into multiple different fields (e.g., pastry cooking, BBQ cooking, Italian cooking, etc.; fielding in baseball, pitching in baseball, batting in baseball, etc.; and other such fields). The field of expertise database associates products that can be used in and/or may be beneficial relative to one or more of multiple different fields of expertise.

In some embodiments, the field of expertise database further associates the different products with one of multiple different virtual reality environments that each correspond to one of the fields of expertise and that correspond to a physical environment in which the corresponding product is expected to be used. Different products have different uses, but are typically used by people in performing one or more tasks within one or more environments. For example, a kitchen knife is typically used by a person in a kitchen environment while cooking and preparing food. Similarly, a sleeping back may be used in a camping environment, while also may be used in a home (e.g., when guests are visiting, children's' sleepovers, etc.). As other examples, a fishing pole is used in a lake and ocean environments, a rifle is used in hunting environments (e.g., lake for duck hunting, mountains for deer hunting, etc.), a couch is used in a home, some offices and other such environments, and a frying pan is used in a kitchen environment. Some products may be used in multiple different environments, such as a screwdriver being associated with a home improvement environment, an automotive environment, and other environments. The field of expertise database and/or an environment database associates different products with different virtual reality environments that correspond to physical environments in which the products are expected to be used. In some embodiments, the environments may be associated with one or more of the fields of expertise. The virtual reality environments are rendered through the rendering systems while providing the advice and/or other information about a product to the customer. For example, a knife may be associated with a kitchen environment, and in rendering expert advice a virtual kitchen environment is rendered as a background in which the virtual expert is positioned when providing the expert advice, such as demonstrating how to properly use the knife, food products on which the knife is intended to be used and/or that the knife is particularly suited, how to properly hold the knife, how to properly care for the knife, and the like.

The expert advice can include general advice such as but not limited type of product particularly effective with some types of activates, benefits of a product, differences of a product relative to one or more other products, and other similar general advice. Further, the expert advice can provide ratings information, such as ratings from customers, ratings from other professionals in one or more relevant fields of use, and/or other such ratings. The expert advice can additionally include advice that is more specific and dependent on a level of expertise and knowledge about a product and one or more fields of expertise and use. For example, the expert advice can provide detailed information about how a product is used, a correct way to use a product, an incorrect way to use a product, incorrect general assumptions often associated with a product or its use, alternative uses of a product, alternative products to use for an activity, and other such expert advice. The expert advice may include highly specific advice, such as precise positioning of fingers when holding and/or using a product to perform a specific activity, an orientation of a person's hand relative to an object on which the product is being used, variations on use, problems that may be experienced and how to overcome those problems, and other such expert advice. The level of advice may further be adjusted based on knowledge of a customer and/or a determined level of knowledge of the customer. For example, the central control system 2002 may access information about the customer indicating the customer regularly cooks, has obtained some instruction in cooking, or other levels of cooking, and can modify the type, quantity and/or level of expert advice to be consistent with a determined level of the customer's expertise in the corresponding field of expertise. Further, the expert advice is presented to the customer with a degree of professionalism to emphasize the reliability of the expert advice. This expert advice information can be accumulated over time from a product manufacturer, input from actual experts, feedback from experts regarding their experiences using a product, research into a manufacturer's claims regarding a product, testing of products, and other such sources.

The central control system 2002 can, in some embodiments, select a virtual reality environment based on the product selected. Further, when a product is associated with multiple environments, the control system can take into consideration one or more other factors in selecting the environment, such as where the customer is located in the shopping facility when expert advice is to be provided, other products the customer has considered, other products the customer as selected for purchase, customer's history of purchases, customer's partiality vectors, other such factors, or a combination of two or more of such factors. A virtual expert can be associated with a virtual reality environment and/or a virtual expert can be selected based in part on an identified virtual reality environment in which the central control system 2002 is going to present the expert advice.

In some embodiments, the central control system 2002 accesses a virtual reality content database 2007 and acquires one or more sets of code to be applied in rendering a virtual reality environment corresponding to the field of expertise and the first product. Similarly, the central control system 2002 can access one or more sets of code to be applied in cooperatively rendering the virtual expert avatar and the virtual product being used by the expert avatar when providing the expert advice, and typically within the virtual environment.

The identified and accessed one or more sets of code can be distributed to one or more rendering systems 2004 of the plurality of rendering systems corresponding to the customer. In some embodiments, the one or more rendering systems may comprise rendering processing systems and separate display systems. The rendering processing systems may be implemented as part of the central control system 2002 or may be a separate processing system. In some embodiments, the implementation of the code causes the rendering systems generate visual and/or audio content to render on one or more display systems, which are distributed throughout the shopping facility, the virtual reality environment and the expert avatar providing expert advice relative to one or more products, and often renders the one or more product being used by the expert avatar. Additionally or alternatively, some or all of the accessed one or more sets of code can be implemented by the central control system 2002 to generate visual and/or audio content that is distributed to one or more display systems. The central control system 2002 causes the first rendering system to visually and/or audibly render the virtual reality environment and an expert avatar that appears as an expert in the field of expertise and that virtually provides expert advice, such as but not limited to illustrating at least how to correctly use the product within a physical environment represented by the virtual reality environment, what other products can be used with the product of interest and/or other products the product of interest is intended to be used with, how to properly hold the product of interest, when to use the product of interest, other uses of the product of interest, other products that can enhance the use of the product of interest, characteristics of the product of interest, benefits of the product of interest, drawbacks of a product of interest, recommended alternative products, rating of a product of interest, other information, and often a combination of two or more of such information. For example, an expert avatar in a field of hunting can show and explain how to load a rifle, show and explain how to hold the rifle, show and explain different types of ammunition to use with the rifle depending on animals being hunted (and where to find the ammunition in the shopping facility or another retailer), how to clean and care for the rifle, identify other products that may be of interest (e.g., a case for the rifle and where to find the case in the shopping facility or other retailer, cleaning kit, carry straps, and the like), and in some instances information about other products that may have a relation to hunting and/or the customer (e.g., camping gear, easily portable food products, hunting clothing, cold weather clothing, etc.).

In some embodiments, the central control system 2002 enables customer to cause modifications within the virtual environment by presenting questions, interacting with a touch screen, performing hand jesters, and other such interactions. For example, a customer can modify an orientation of a rendered product. The central control system 2002 can receive and/or detect input from the customer, typically while the customer is in the shopping facility and viewing the rendered expert avatar depicted within the virtual reality environment. The input from the customer can correspond to a desired modification of a visual orientation of the product relative to its virtual use by the expert avatar. For example, the customer may rotate her/his hand and one or more sensors may detect the rotation and cause the avatar expert to similarly rotate the product (e.g., to show from a different angle how the avatar expert is holding a product). As another example, the customer may touch a touch screen display on a predefined menu option or through one or more predefined touch patterns to cause a modification of the product orientation, a modification of an orientation of the virtual environment, a modification of an orientation of the avatar expert, and/or other such modifications. Based on the received input, the control circuit can identify and cause one or more sets of code to be implemented and/or distributed to the one or more rendering systems to cause a modification to the customer's visual orientation relative to the rendered product and the expert avatar.

An expert database 2008 identifies multiple publically known experts and further associates one or more fields of expertise with each of the experts for which each of the experts is publically considered to be an expert. For example, one or more publically known chefs from one or more cooking shows and/or books could be associated with one or more cooking fields based in part on being a famous chef. As such, the expert database maintains a listing of publically know experts that are publically known for having an expertise in one or more fields. The central control system 2002 can select, from the expert database, an expert that is generally considered by the general public to be an expert in a field of expertise based in part on the product the customer is interested in and/or for which the system is providing advice. In some embodiments, the central control circuit selects the public expert on which the avatar is to be based in accordance with customer preferences, partiality vectors, historical interaction with the system, input from the customer, knowledge regarding a customer's television viewing habits, and/or other relevant information. Additionally or alternatively, the system may allow a customer to select an expert avatar and/or select a person on which the expert avatar is to be based (e.g., provide a listing of chefs and allow a customer to select one of those chefs). When rendering of the avatar, the central control system 2002 can cause the rendering of the avatar to appear as the publically known expert, and may further present the avatar with mannerisms, speech, phrases and the like similar to those of the publicly known expert.

Some embodiments use partiality vectors to identify a virtual field of expertise, products that a customer might be interested in and that correspond to a product for which the system in providing the customer with expert advice, identify a publically known expert on which to base an avatar, other such decisions, or combinations of such decisions. In some implementations, one or more customer databases 2009 can be accessed and/or maintained, and that includes an identifier for each of multiple customers, and for each customer associates customer partiality vectors with the customer. The customer partiality vectors are directed quantities that each have both a magnitude and a direction, with the direction representing a determined order imposed upon material space-time by a particular partiality and the magnitude represents a determined magnitude of a strength of the belief, by the customer, in a benefit that comes from that imposed order. The customer database may include customer profiles and/or otherwise associate other parameters with a customer, such as but not limited to purchase history, product preferences, methods of payment, previous expert advice provided, previous avatars used in providing expert advice, feedback parameters based on customer's action in relation to expert advice provided (e.g., whether the customer purchased a product for which expert advice was provided, whether the customer purchased one or more other products that was associated with the product of interest when providing expert advice, not purchasing a product, other products considered prior to and after receiving expert advice, duration of time between receiving the expert advice and making a purchase, other such parameters), family members information, activities in which the customer and/or family members participate (e.g., sports, exercise, travel, types of vacations, etc.), other parameters, and typically a combination of two or more of such parameters. The central control system, in some applications, can use the partiality vectors and/or other customer parameters to identify the field of expertise, a publicly known person on which to base an avatar, and other such selections. For example, the central control system 2002 can identify a field of expertise based on one or more partiality vectors defined for a customer. Additionally or alternatively, the central control system 2002 can further identify, based on the partiality vectors associated with a customer, adjustable characteristics corresponding to one or more products and consistent with the partiality vectors that can be used in part when rendering expert advice, so that the set of code can be distributed as defined in part by the adjustable characteristics and to cause the visually rendering of the product consistent with the adjustable characteristics. Such adjustable characteristics can include color, size, quantity, gender relation, graphics, and other such characteristics. As such, when rendering the expert advice, the product of interest and/or associated products can be rendered in a way that is consistent with the customer's partiality vectors emphasizing characteristics that are valuable to the customer (e.g., ease of use, effectiveness, etc.), as well as rendering the product consistent with how the customer is likely going to want to product.

As described above, in some embodiments the central control circuit in distributing the set of code causes the rendering of how components of a product operate together and based on the intended use of the product illustrates how that product is used with other products, and/or recommends other products to be used with the product of interest. In some applications, the central control circuit can cause the virtual rendering of one or more other products in use with the product of interest and within the virtual reality environment. For example, when the product of interest is a knife, the central control system 2002 can cause the rendering to illustrate products that can be used with the knife, showing other product being cut by the knife and how to accurately use the knife when cutting those products.

In some embodiments, the central control system 2002 communicatively couples with a series of sensors and further uses sensor information to determine a location of a customer, track a customer's progress through the shopping facility, identify the customer and/or other such actions. As introduced above, the series of sensors can include sensors positioned and distributed in multiple locations in the shopping facility that communicate sensor information to the central control system. The central control system 2002 can identify a customer, such as through facial recognition, RFID tag of a customer tag carried by the customer, detect a customer's user interface unit 1818 (e.g., through Wi-Fi), and/or other such sensor information. The customer's location within the shopping facility can be identified based on the sensor data. The central control system 2002 can further identify, based on the location within the shopping facility and products located proximate the location, a virtual reality environment and/or a field of expertise that is to be rendered to the first customer.

In some embodiments, the location of the customer can further be used to identify one or more rendering systems to use in rendering the expert advice to the customer. The central control system 2002 typically knows where fixed rendering systems are located within the shopping facility and may track the movement of other rendering systems (e.g., rendering systems secured with a shopping cart, customers' user interface units 1818, and other such rendering systems). With knowledge of the location of the customer, the central control system 2002 can direct one or more of the rendering systems that are within one or more threshold distances of the customer to be activated to cause the rendering of the virtual reality environment, the avatar and when relevant the virtual product. The threshold distance can vary depending on one or more factors such as but not limited to proximity of other customers, whether the system is using the customers user interface unit as part of a rendering system, a customer's orientation relative to the rendering system, levels of ambient noise, whether the customer is accompanied by other customers or individuals (e.g., children), and other such factors.

The customer support system 2000 can provide customer with access to expert advice while the customers shop in the shopping facilities. In some embodiments, the system further provides customers to access expert advice while outside the shopping facility. A customer can access an ordering system (e.g., through a web interface of an Internet site) to browse products and/or request expert advice. Similarly, in some embodiments the customers can access previously accessed expert advice to re-watch the expert advice and/or link to other related advice and/or information.

In some embodiments, the central control circuit can track expert advice and/or other information provided to a customer regarding a product. This information can be maintained to allow a customer to readily re-access the same or similar information at a future time. For example, the central control circuit can cause one or more expert advice identifiers to be associated with a customer identifier (e.g., in a customer's user profile). Upon accessing a customer account, for example through a graphical user interface displayed through a user interface unit (e.g., computer, smartphone, tablet, etc.), one or more options may be provided to allow a customer to access previous expert advice, a historical listing of expert advice previously accessed, a listing of products for which expert advice was provided, links to related expert advice (e.g., other uses expert advice, alternative products expert advice, etc.) and/or other such options that allow a customer to access previously accesses expert advice and in some instances other related expert advice.

Some embodiments identify one or more sets of avatar characteristics to be applied in rendering a virtual avatar. In some instances, the avatar characteristics can correspond to a customer and/or be based on the field of expertise. Further, the avatar characteristics to be applied maybe identified based on the identified field of expertise and/or a specific customer. The set of avatar characteristics are configured to be applied in customizing, for a customer, a rendered customized avatar within a virtual reality environment corresponding to the field of expertise and the product of interest. The central control system 2002 in distributing one or more sets of code to cause the rendering of the virtual reality environment and information corresponding to a product of interest can cause code to be distributed to one or more rendering systems of the plurality of rendering systems corresponding to the customer to cause the rendering system to visually render the virtual reality environment and the avatar as customized according to the set of one or more avatar characteristics. Again, the rendered customized avatar can virtually illustrate aspects of the product of interest, such as but not limited to how to correctly use the product within a physical environment represented by the virtual reality environment, features that distinguish the product over other products, features of the product that simply its use, features that improve performance, cost information, other such features, or combination of such features.

As introduced above, the expertise database identifies and/or lists multiple different products for which customer assistance is available. In some embodiments, the expertise database identifies different areas of expertise for which an avatar can use and/or identifies avatar characteristics associated with a field of expertise and that correspond to a particular customer, and which may be applied when providing expert advice in that field of expertise. The expertise database may further associate, for each of the multiple different products, at least a sub-set of a set of code corresponding with one of the multiple different products and at least one of the fields of expertise. The sub-set of code can define one or more types of expertise and/or that can be applied in providing a customer with expert advice regarding the use of a corresponding product, and in some instances other products to be used with the corresponding product.

The customized characteristics may be specified by a customer, learned over time, and modified over time. Some embodiments provide an avatar customization user interface that allows a customer to access customization characteristics that can be selected and/or define how characteristics are to be applied (e.g., applied only relative to one or more specific fields of expertise, applied globally, applied to specific types of products, applied based on one or more manufacturers, and the like). The central control circuit is further configured to monitor over time a customer's interaction with a customized avatar and to modify the customization database and one or more of the avatar characteristics based on the customer's interaction with the customized avatar. Similarly, the central control circuit can track customers' reactions to interactions with an avatar and make modifications to one or more databases regarding which and when to apply avatar characteristics when providing expert advice to a particular customer. For example, the central control system 2002 can use customers' purchases and/or non-purchases relative to information provided by an avatar about one or more products, track customers' requests and input (e.g., response to questions by the avatar) while and/or after viewing an avatar, facial changes and/or reactions during interaction with an avatar, customers' movements through the shopping facility during and/or following interaction with an avatar, other such actions and/or reactions, and often a combination of two or more of such actions and/or reactions.

The customized characteristics may further define when an avatar is not to be rendered and/or provide advice. This can be advantageous to anticipate a customer's desire to obtain advice and/or when a customer does not want to receive advice. In some applications, for example, the avatar characteristics can define when to avoid rendering the customized avatar while a customer is within an area of the shopping facility corresponding to a particular field of expertise. For example, the central control system 2002 can be told (e.g., by the customer) or learn over time that a customer does not want advice while in certain parts of the shopping facility (e.g., customer prefers to be left alone). Similarly, the system can identify when a wants advice and/or when it may be beneficial to provide advice. For example, the system can learn over time that a particular customer is likely to prefer some advice when the customer is considering a particular product for more than a threshold period of time, when a customer is within an area of the shopping facility for more than a threshold period of time (e.g., within a breakfast cereal aisle, within a threshold distance of certain kinds of product, other such areas), when a customer returns to an area a threshold number of times and/or a customer considers a same or competing product a threshold number of times (which may be restricted to a single visit or multiple different visits to the shopping facility), and other such conditions.

The system can modify the avatar and/or present completely different avatars as the customer moves from one location to another location within the shopping facility (e.g., based on field of expertise associated with those different areas) and/or as the customer considers different products. As such, the system may emphasize different avatar customization characteristics between different virtual environments and/or relative to different fields of expertise. The central control system 2002 may, in some embodiments, identify a subsequent product for which a customer may like or is requesting expert advice (e.g., advice on how to use the subsequent product, and access the field of expertise database to identify one or more additional fields of expertise associated with the subsequent product. Based on the identified additional field of expertise, one or more other sets of avatar characteristics corresponding to the customer and the subsequent field of expertise and/or subsequent product can be identified. The other set of avatar characteristics are configured to be applied in modifying the rendered customized avatar consistent with the other set of avatar characteristics while rendered within the same or a different virtual reality environment corresponding to the subsequent field of expertise and/or the subsequent product.

Some embodiments use customer profile information, partiality vectors and/or other customer information to define and/or select some of the avatar characteristics when rendering an avatar. In some implementations, the customer database 2009 can associate or include avatar characteristics, aspects used to determine avatar characteristics, and other information. The central control system 2002 may select and/or define at least some of the avatar characteristics within the customization database based on a set of one or more partiality vectors specific to the customer. These partiality vectors may be learned over time and used to identify avatar characteristics that may be more appealing to a customer. For example, an avatar may be presented to look and sound like a well-known person that is also known for her/his involvement with animal rights when presenting advice or other information to a customer about a product, features of a product and/or the manufacturing of a product, when the customer is known to have partiality vectors toward animal rights. In some embodiments, the central control system 2002 can be configured to use partiality vectors associated with a customer to identify, based on a set of one or more partiality vectors, one or more products in which the customer is expected to be interested. Further, the system can autonomously present information about at least one of the one or more products (which can include information consistent with the set of partiality vectors) to the customer through the rendering of the customized avatar. In some instances, this information is presented without prompting from the customer.

Partiality vectors can change over time and/or revisions to the partiality vectors may be applied (e.g., changes over time to a magnitude, changes in alignment, etc.). Some of these changes may be identified from customer actions. In some embodiments, the central control system 2002 can identify a set of multiple partiality vectors that affect avatar characteristics. Some or all of the multiple partiality vectors may be modified over time based on customer purchases and actions by the customer in response to one or more customized avatars being viewed by the customer. Based on the modifications to the partiality vectors, some embodiments may further modify over time one or more avatar characteristics of a set of avatar characteristics associated with the one or more fields of expertise.

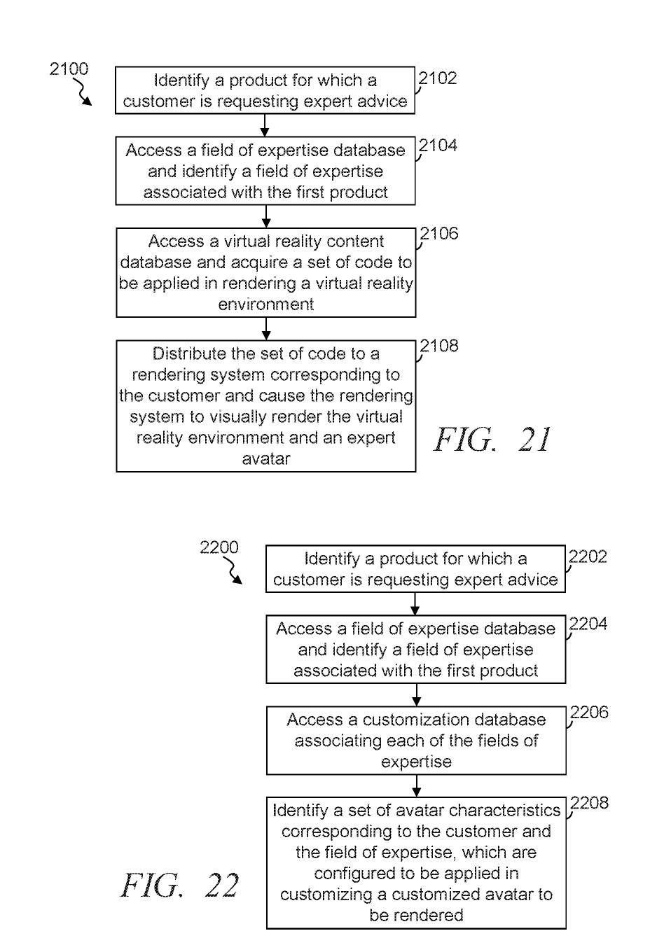

FIG. 21 illustrates a simplified flow diagram of an exemplary process 2100 of supporting customers while shopping and providing customers with expert advice, in accordance with some embodiments. In step 2102, a product is identified for which a customer is requesting expert advice on how to use a product. This identification can be based on sensor information, information provided by a customer (e.g., through a user interface unit and/or a rendering system the customer can identify a product). In step 2104, a field of expertise database is accessed, and a field of expertise is identified that is associated with the product. Again, the field of expertise database associates each of multiple products with one or more of multiple different fields of expertise and with one of multiple different virtual reality environments each corresponding to one of the fields of expertise and that correspond to an environment in which the product is expected to be used.

In step 2106, a virtual reality content database is accessed and from which is identified and/or acquired one or more sets of code to be applied in rendering a virtual reality environment corresponding to the field of expertise and the product. This code and/or other code can include for example code regarding the rendering of the virtual reality environment, an expert avatar, an avatar of the product, an avatar of other products, other such information, and often a combination of such code. In step 2108, the one or more sets of code can be distributed to one or more rendering systems, of the plurality of rendering systems positioned within a retail shopping facility (e.g., fixed display systems, mobile rendering systems, customers' user interface units, etc.) and corresponding to the customer, and cause the selected one or more rendering systems to visually and/or audibly render the virtual reality environment and an expert avatar that appears as an expert in the field of expertise and that provides expert advice. In some embodiments, the expert advice can include virtually illustrating at least how to correctly use the product within a physical environment represented by the virtual reality environment.

Some embodiments receive, while the customer is in the shopping facility and viewing the rendered expert avatar depicted within the virtual reality environment, input from the customer corresponding to a desired modification of a visual orientation of the product and/or avatar relative to the products virtual use by the expert avatar. Based on the received modification information, a second set of code can be caused to be distributed to the rendering system to cause a modification to the customer's visual orientation relative to the rendered product and the expert avatar. In selecting the expect, from an expert database identifying multiple publically known experts and associating one or more fields of expertise with each of the experts for which each of the experts is publically considered to be an expert, some embodiments select the expert with the first expert being identified in the expert database as generally considered by the general public to be an expert in the field of expertise. In rendering of the avatar the system can cause the rendering of the avatar to appear as one of the publically known experts.

In some embodiments, sensor data is received from at least one sensor of a series of sensors positioned and distributed in multiple locations in the shopping facility. The product may be identifying as a product being touched by the customer based on the sensor information received from the at least one sensor of the series of sensors. Customers can be identified, and a customer database can be accessed. The customer database, in some implementations can include an identifier for each of multiple customers, and for each customer associates customer partiality vectors with the customer. The field of expertise can be identified based on a partiality vector defined for a particular customer. Some embodiments identify, based on the partiality vectors associated with a customer, adjustable characteristics corresponding to a product and consistent with the partiality vectors. In distributed the set of code can comprise code as defined in part by the adjustable characteristics, while causing the visually rendering of the product consistent with the adjustable characteristics.

The system can further be configured to identify other products to be recommended for used with the product of interest and for which advice is to be provided. In distributing the set of code, some embodiments distribute the set of code causing the rendering of how components of the product operate together and based on the intended use of the product further cause a virtual rendering of at least one of the other products in use with the product within the virtual reality environment. In some embodiments, sensor information is received from at least one sensor of a series of sensors positioned and distributed in multiple locations in the shopping facility. A customer can be identified, and a location within the shopping facility of the first customer can be identified based on the sensor data. Based on the location within the shopping facility and products located proximate the location, a virtual reality environment and a field of expertise can be identified that is to be rendered to the customer.

FIG. 22 illustrates a simplified flow diagram of an exemplary process 2200 of supplying advice to customers while the customers are shopping, in accordance with some embodiments. In step 2202, a product is identified for which a customer is requesting expert advice on how to use the product. The system may detect the request based on customer actions (e.g., looking at a product or type of products for a threshold period of time, customer handling or picking up a product, etc.), the customer submitting a specific request (e.g., interacting with a customer user interface of a rendering device or user interface unit), or other such actions.

In step 2204, the field of expertise database is accessed and a field of expertise is identified that is associated with the product. As described above, the field of expertise database can associate products with one or more of multiple different fields of expertise and with one of multiple different virtual reality environments each corresponding to one of the fields of expertise and that correspond to an environment in which a product is expected to be used. In step 2206, a customization database is accessed that associates each of the fields of expertise with a respective set of one or more avatar characteristics. In step 2208, a set of avatar characteristics are identified, based on the identified field of expertise, corresponding to the customer and the field of expertise. Typically, the set of avatar characteristics are configured to be applied in customizing for the customer a customized avatar to be rendered on one of a plurality of virtual reality rendering systems positioned within the shopping facility and rendered within a virtual reality environment corresponding to the field of expertise and the product.

Some embodiments distribute a set of code to one or more rendering systems corresponding to the customer to cause the rendering system to visually render the virtual reality environment and the customized avatar that virtually illustrates at least how to correctly use the product within a physical environment represented by the virtual reality environment. The rendering system may be identified as being within a threshold distance of the customer, within a threshold distance of where a product the customer is considering is located, a user interface unit owned by the customer, or other aspects used to identify a rendering system that at least temporarily corresponds with a customer. The system may confirm that expert advice is available for the product by, in part, accessing an expertise database identifying multiple different products for which customer assistance is available, and for each of the multiple different products associates a sub-set of the set of code corresponding with one of the multiple different products and at least one of the fields of expertise. The sub-set of the code may define one or more types of expertise regarding the use of the corresponding product and other products to be used with the corresponding product.

The customer's interaction with the customized avatar and/or actions following an avatar being presented to the customer can be monitored over time. Based on the customer's interactions with one or more customized avatars and/or actions, the system may modify the customization database and one or more of the avatar characteristics. The customer's actions may include questions presented by the customer, the duration the customer observes and/or interacts with the avatar, a purchase made by the customer, customer's route through the shopping facility, and/or other such information. The customized characteristics can include many different types of characteristics that can be applied, modified, and/or removed. For example, the characteristics can include appearance characteristics (e.g., eye color, eye size, eye shape, face shape, skin color, skin tone, hair color, hair style, hair length, gender, apparent height, apparent weight, spoken language, dialect, accent, rate or speed of speech, types of hand gestures used, when to present an avatar, duration an avatar should be presented, type of information to present through the avatar and/or associated with the avatar, whether the avatar is a publically recognizable person, other such characteristics, and typically a combination of two or more of such characteristics. For example, one or more customized characteristics define when an avatar is or is not to be rendered. As a further example, the system can avoid rendering the customized avatar as defined by the avatar characteristics while the customer is within an area of the shopping facility corresponding to a particular field of expertise.

Some embodiments can identify one or more other products for which a customer is requesting expert advice. The field of expertise database can be accessed to identify one or more other fields of expertise associated with another product. Based on the identified other field of expertise, a second set of avatar characteristics corresponding to the customer and the other field of expertise can be identified and applied. In some instances, for example, the second set of avatar characteristics can be configured to be applied in modifying the rendered customized avatar consistent with the second set of avatar characteristics while rendered within a second virtual reality environment corresponding to the other field of expertise and the other product.

As described above, some embodiments use partiality vectors to define some of the avatar characteristics. In some instances, a customer database is accessed that comprises an identifier for each of multiple customers, and for each customer associates customer partiality vectors with the customer. At least some of the avatar characteristics can be defined within the customization database based on at least a set of one or more partiality vectors specific to the customer. Some embodiments, based on the set of one or more partiality vectors, identify at least one product in which the customer is expected to be interested. The system can be configured to autonomously present through the rendering of the customized avatar and without prompting from the customer information about the product. Additionally, some embodiments identify another set of one or more partiality vectors that affect avatar characteristics, which may include the first set of one or more partiality vectors. One or more of the set of multiple partiality vectors may be modified over time based on customer purchases and actions by the customer in response to one or more customized avatars being viewed by the customer. Further, based on the modifications to the multiple partiality vectors, some embodiments modify over time avatar characteristics of at least one of the sets of one or more avatar characteristics associated with the fields of expertise.

Some embodiments provide systems to supply advice to customers while shopping, comprising: a plurality of virtual reality rendering systems positioned within a retail shopping facility; a field of expertise database associating each of multiple products with one or more of multiple different fields of expertise and with one of multiple different virtual reality environments each corresponding to one of the fields of expertise and that correspond to an environment in which the product is expected to be used; a customization database associating each of the fields of expertise with a respective set of one or more avatar characteristics; and a central control system comprising a central control circuit coupled with memory storing code that when implemented causes the central control circuit to: identify a first product for which a first customer is requesting expert advice on how to use the first product; access the field of expertise database and identify a first field of expertise associated with the first product; and identify, based on the identified first field of expertise, a first set of avatar characteristics corresponding to the first customer and the first field of expertise, wherein the first set of avatar characteristics are configured to be applied in customizing for the first customer a rendered customized avatar within a first virtual reality environment corresponding to the first field of expertise and the first product. The central control circuit, in some implementations, is configured to distribute a first set of code to a first rendering system of the plurality of rendering systems corresponding to the first customer to cause the first rendering system to visually render the first virtual reality environment and the customized avatar that virtually illustrates at least how to correctly use the first product within a physical environment represented by the first virtual reality environment.

In some embodiments, the system further comprises: an expertise database identifying multiple different products for which customer assistance is available, and for each of the multiple different products associates a sub-set of the first set of code corresponding with one of the multiple different products and at least one of the fields of expertise, wherein the sub set of the first set of code is to be applied in rendering one or more types of expertise regarding the use of the corresponding product and other products to be used with the corresponding product. The central control circuit may further be configured to monitor over time the first customer's interaction with the customized avatar and to modify the customization database and one or more of the avatar characteristics based on the first customer's interaction with the customized avatar. In some instances, the avatar characteristics define when to avoid rendering the customized avatar while the first customer is within an area of the shopping facility corresponding to a second field of expertise. The central control circuit may be configured to: identify a second product for which the first customer is requesting expert advice on how to use the second product; access the field of expertise database and identify a second field of expertise associated with the second product; and identify, based on the identified second field of expertise, a second set of avatar characteristics corresponding to the first customer and the second field of expertise, wherein the second set of avatar characteristics are configured to be applied in modifying the rendered customized avatar consistent with the second set of avatar characteristics while rendered within a second virtual reality environment corresponding to the second field of expertise and the second product.

In some embodiments, the system further comprises: a customer database comprising an identifier for each of multiple customers, and for each customer associates customer partiality vectors with the customer, wherein the customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order; wherein the central control circuit defines at least some of the avatar characteristics within the customization database based on at least a first set of one or more partiality vectors specific to the first customer. The central control circuit may be configured to identify, based on the first set of partiality vectors, at least one product in which the first customer is expected to be interested, and autonomously present through the rendering of the customized avatar and without prompting from the first customer information about the at least one product. In some implementations, the central control system is configured to: identify a second set of multiple partiality vectors that affect avatar characteristics, wherein the second set of multiple partiality vectors comprises the first set of one or more partiality vectors; modify over time two or more of the second set of multiple partiality vectors based on customer purchases and actions by the customer in response to one or more customized avatars being viewed by the first customer; and modify over time, based on the modifications to the two or more of the multiple partiality vectors, avatar characteristics of at least one of the sets of one or more avatar characteristics associated with the fields of expertise.

Some embodiments provides methods of supplying advice to customers while shopping, comprising: by a central control circuit of a retail shopping facility: identifying a first product for which a first customer is requesting expert advice on how to use the first product; accessing a field of expertise database and identifying a first field of expertise associated with the first product, wherein the field of expertise database associates each of multiple products with one or more of multiple different fields of expertise and with one of multiple different virtual reality environments each corresponding to one of the fields of expertise and that correspond to an environment in which the product is expected to be used; accessing a customization database associating each of the fields of expertise with a respective set of one or more avatar characteristics; and identifying, based on the identified first field of expertise, a first set of avatar characteristics corresponding to the first customer and the first field of expertise, wherein the first set of avatar characteristics are configured to be applied in customizing for the first customer a customized avatar to be rendered on one of a plurality of virtual reality rendering systems positioned within the shopping facility and rendered within a first virtual reality environment corresponding to the first field of expertise and the first product. In some instances, method further comprises: distributing a first set of code to a first rendering system of the plurality of rendering systems corresponding to the first customer to cause the first rendering system to visually render the first virtual reality environment and the customized avatar that virtually illustrates at least how to correctly use the first product within a physical environment represented by the first virtual reality environment.

The method, in some embodiments, further comprises: confirming expert advice is available for the first product comprising accessing an expertise database identifying multiple different products for which customer assistance is available, and for each of the multiple different products associates a sub-set of the first set of code corresponding with one of the multiple different products and at least one of the fields of expertise, wherein the sub set of the first set of code defines one or more types of expertise regarding the use of the corresponding product and other products to be used with the corresponding product. In some applications, the method further comprises: monitoring over time the first customer's interaction with the customized avatar; and modifying the customization database and one or more of the avatar characteristics based on the first customer's interaction with the customized avatar. The method may further comprise: avoiding rendering the customized avatar as defined by the avatar characteristics while the first customer is within an area of the shopping facility corresponding to a second field of expertise.

In some embodiments, the method further comprises: identifying a second product for which the first customer is requesting expert advice on how to use the second product; accessing the field of expertise database and identify a second field of expertise associated with the second product; and identifying, based on the identified second field of expertise, a second set of avatar characteristics corresponding to the first customer and the second field of expertise, wherein the second set of avatar characteristics are configured to be applied in modifying the rendered customized avatar consistent with the second set of avatar characteristics while rendered within a second virtual reality environment corresponding to the second field of expertise and the second product. The method may further comprises: accessing a customer database comprising an identifier for each of multiple customers, and for each customer associates customer partiality vectors with the customer, wherein the customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order; and defining at least some of the avatar characteristics within the customization database based on at least a first set of one or more partiality vectors specific to the first customer.

In some embodiments the method further comprises: identifying, based on the first set of partiality vectors, at least one product in which the first customer is expected to be interested; and autonomously presenting through the rendering of the customized avatar and without prompting from the first customer information about the at least one product. The method may further comprise: identifying a second set of multiple partiality vectors that affect avatar characteristics, wherein the second set of multiple partiality vectors comprises the first set of one or more partiality vectors; modifying over time two or more of the second set of multiple partiality vectors based on customer purchases and actions by the customer in response to one or more customized avatars being viewed by the first customer; and modifying over time, based on the modifications to the two or more of the multiple partiality vectors, avatar characteristics of at least one of the sets of one or more avatar characteristics associated with the fields of expertise.

Some embodiments comprise a system to support customers while shopping, comprising: a plurality of virtual reality rendering systems; a field of expertise database associating each of multiple products with one or more of multiple different fields of expertise; a customization database associating each of the fields of expertise with a respective set of one or more avatar characteristics; and a central control system configured to: identify a product for which a customer is requesting expert advice; access the field of expertise database and identify a field of expertise associated with the product; and identify a set of avatar characteristics corresponding to the customer and the field of expertise that are configured to be applied in customizing a rendered customized avatar within a virtual reality environment corresponding to the field of expertise and the product.

Various embodiments provide an apparatus comprising a virtual-reality user interface, a memory containing virtual-reality presentation information for a plurality of items available for retail sale as well as information including a plurality of partiality vectors for a particular customer, and a control circuit that operably couples to both the virtual-reality user interface and the memory. The control circuit is configured to select a particular one of the plurality of items to present to the customer via the virtual-reality user interface as a function, at least in part, of the partiality vectors. The virtual-reality user interface can include, for example, an audio-content user interface and/or an active haptic-content user interface along with a visual interface.

By one approach the virtual-reality user interface provides a user with a product showroom experience. By another approach the virtual-reality user interface provides the user with a virtual real-world setting other than in a product showroom. In either case the control circuit can present particular ones of a plurality of items in an order of presentation that begins with a product that best accords with the customer's partiality vectors and where the order of presentation continues with products that increasingly less accord with the customer's partiality vectors.

These teachings will accommodate permitting a customer to edit at least one of the aforementioned partiality vectors and/or to temporarily override a given partiality vector to thereby adjust the selection and presentation of products accordingly.

So configured, a customer can experience a virtual presentation of products that are very likely to accord with their own partialities. At the same time, this virtual presentation can exclude products that do not sufficiently accord with the customer's partialities. The result is a shopping experience that can greatly facilitate helping the customer to find an appropriate product selection.

To provide a shopping experience customized to a particular customer, shopper, or user, the system, in one illustrative embodiment, includes one or more sensors configured to detect the presence or movement of users in the retail shopping facility such that a virtual-reality enabled location in the facility can provide, via a virtual-reality user interface, a visual, audio, and/or haptic display for a particular user based, in part, on the partiality vectors associated with that the particular user. Further, the virtual-reality user interface can adjust visual, audio, and/or haptic aspects of the virtual-reality user interface pursuant to any changes in a single user or multiple users' partiality vectors.

The virtual-reality enabled location and one or more virtual-reality user interface associated therewith may provide augmented-reality elements in a physical user environment. Further, the virtual-reality user interface may include portable devices and/or those installed at a virtual-reality enabled location in the retail shopping facility. Therefore, as used herein, the virtual-reality enabled locations include areas within the retail shopping facility that have at least one of: one or more installed devices of the virtual-reality user interface and/or an area into which mobile devices of the virtual-reality user interface can be advanced into and updated or changed in light of the presence of the mobile device in the virtual-reality enabled location.

In one exemplary embodiment, a shopping display system includes a user database of user profiles having one or more partiality vectors associated with particular users, one or more sensors detecting movements of users in the retail shopping facility, the sensor detecting when a particular one of the users enters one or more virtual-reality enabled locations within the retail shopping facility, a virtual-reality user interface at the retail shopping facility at the one or more virtual-reality enabled locations and configured to display visual, audio, and/or haptic information pertaining to retail products, and a control circuit in communication with the user database and the virtual-reality user interface.

By one approach, the control circuit is configured to receive an indication, via a sensor, of the presence of a particular one of the users within a virtual-reality enabled location, access the user database and the one or more partiality vectors associated with the particular one of the users within the virtual-reality enabled location, and instruct the virtual-reality user interface to present or adjust the visual, audio, and/or haptic information presented, in part, in response to detection of the particular one of the users in the virtual-reality enabled location and the partiality vectors associated with the particular detected customer. Accordingly, in operation, the virtual-reality user interface may be configured to adjust the audio, visual, and/or haptic aspects of the virtual-reality user interface to change the display of retail products based, in part, on the one or more partiality vectors associated with the particular one of the users within the virtual-reality enabled location thereby highlighting products of interest to the particular one of the users.

As used herein, the virtual-reality user interface may include at least one of a mobile device, handheld device, a wearable device, and/or an installed device that is installed or otherwise mounted into one of the virtual-reality enabled locations within the retail shopping facility. Accordingly, the virtual-reality user interface may include one or more devices, such as, for example, data eyewear or data glasses, a touch screen, a graphical user interface, a display screen, a digital projector, a spatial augmented reality projector, a speaker, headphones, lights, a haptic feedback device, a microphone, a camera, an optical sensor, a tactile electronic display, an accessory object, a head-mounted audio-visual display, and/or a kiosk.

In addition to presenting information or displaying products, the virtual-reality user interface is configured to receive information from the users and further adjust the audio, visual and/or haptic aspects of a particular display. The information received form the virtual- reality user interface also may be used to update the particular user's user profile including the partiality vectors associated therewith.

As noted above, one or more sensors may be configured to detect the presence of a shopper or user within a virtual-reality enabled location or area of the retail shopping facility. These sensors may track movement of the users within the retail facility. By one approach, the system may incorporate a plurality of sensors to track the movements of users within the retail shopping facility. In one illustrative example, one or more a geo-fences are used to indicate when a user enters the retail shopping facility and/or one of the virtual-reality enabled locations. As used herein, the sensors may employ at least one of RFID, cellular, and/or Wi-Fi communications.

In operation, the system may include a presentation database of virtual-reality presentation information that may be used to determine how and what to present, including marketing and product information, related to the plurality of retail products displayed and provided at the retail shopping facility. The presentation database may be updated, for example, based on product changes, the types and locations of the virtual-reality enabled locations in the retail shopping facility, marketing campaigns, and additional or changing products sold at the retail shopping facility.

By one approach, the control circuit may be configured to access the presentation database and analyze the presentation database, the user profile of the particular customer, and the detected location of the particular one of the users to determine what presentation, display, or adjustments to the visual, audio, and/or haptic aspects to provide to a particular user, via the virtual-reality user interface, at one of the virtual-reality enabled locations.

To facilitate payment for the retail products sold at the retail shopping facility, the virtual-reality user interface may include a payment module enabling purchase of one of the retail products. In addition, the system may include a point of sale terminal in communication with the control circuit and the control circuit updating the user database according to purchases made by the particular user at the point of sale terminal. Indeed, the purchase information from the payment module and/or the point of sale terminal may be used to update the partiality vectors and the user profile of the associated users.

In addition to the partiality vectors, the user profile may include a shopping list for a particular user or a purchase history. Further, the user database and user profiles therein may be updated substantially in real time. Accordingly, the shopping display system described herein, which has access to user profiles with the partiality vectors associated therewith, also may have access to shopping lists associated with users and/or lists of retail items typically or frequently purchased by users according to their purchase history. As outlined herein, the shopping system can highlight such products when the customer or user is within a certain aisle or approaches an area where those products are placed, such as via a virtual-reality user interface at a virtual-reality enabled location in the retail shopping facility. Further, the shopping system, by accessing a user profile with the partiality vectors and other information associated therewith, can provide a virtual showroom that augments the user's reality by adjusting or customizing the content on the virtual-reality user interface, which may be installed at or impacted by the user's presence in a virtual-reality enabled location within the retail shopping facility.

In operation, these teachings may include maintaining a user database of user profiles having one or more partiality vectors associated with particular users, tracking movement of users within a retail shopping facility, detecting when a particular user enters a virtual-reality enabled location within the retail shopping facility, accessing, via a control circuit, the user database to determine the one or more partiality vectors associated with the particular user, and displaying, via a virtual-reality user interface, visual, audio, or haptic information pertaining to retail products for sale in the retail shopping facility based, in part, upon the one or more partiality vectors associated with the particular user.

Further, in operation, the virtual-reality user interface may adjust visual, audio, and/or haptic aspects of the displayed information pertaining to the retail products for sale. In addition, the virtual-reality user interface may receive audio, visual, and/or haptic input from the particular user. Accordingly, the virtual-reality user interface may adjust the visual, audio, and/or haptic aspects of the displayed information pertaining to the retail products for sale based on the input received.

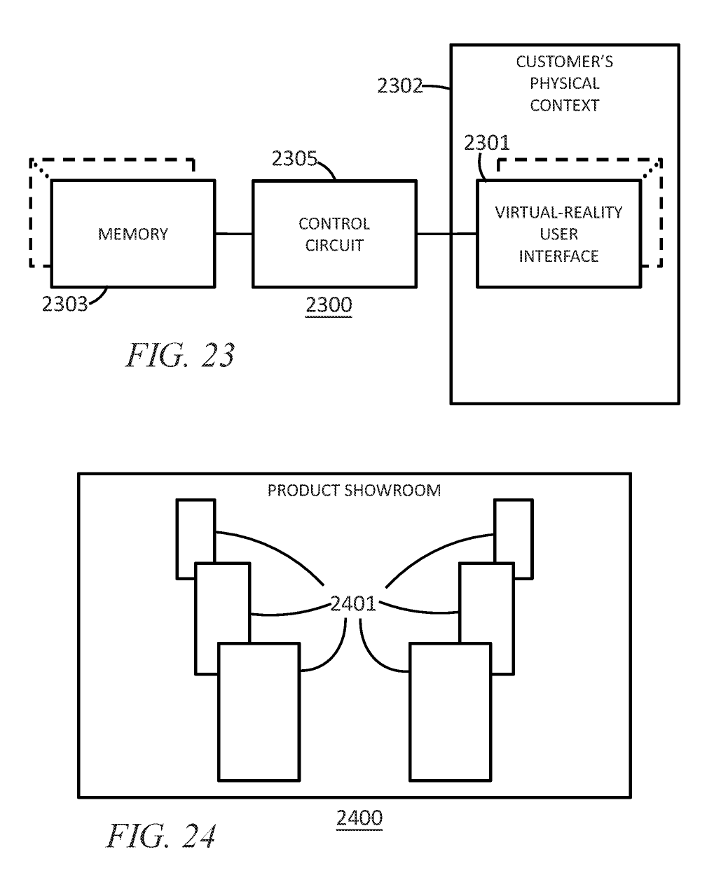

FIG. 23 presents an apparatus 2300 configured to utilize and leverage such partiality vectors in a virtual-reality application setting. In this example the aforementioned control circuit 2305 operably couples to at least one virtual-reality user interface 2301. “Virtual reality” refers to a technology that replicates an environment, real or imagined, and simulates a user's physical presence and environment in a way that allows the user to interact with that replicated environment. Virtual realities artificially create sensory experience, which can include sight, touch, hearing, and even, in some cases, smell.

Virtual reality is typically understood to refer to a substitution of a present local reality for an artificial reality. As used herein, however, references to virtual reality will also be understood to include so-called augmented reality. Augmented reality refers to a live (direct or indirect) view of a physical, real-world environment whose elements are augmented (or supplemented) by computer-generated sensory input such as sound, video, or other sensory content.

There are numerous virtual-reality user interfaces known in the art and improvements are being introduced at a rapid pace. These teachings will accommodate virtual- reality user interfaces that include a visual component as well as an audio-content component if desired. The virtual-reality user interface 2301 may comprise, at least in part, a head-worn component as typifies many existing approaches. These teachings will also accommodate a virtual-reality user interface that includes an active haptic-content user interface to thereby provide an opportunity for the user to manipulate, for example, a virtual product by experiencing virtual touching of that virtual product. Specially designed gloves, for example, exemplify one approach in these regards.

These teachings will accommodate locating the virtual-reality user interface 2301 in any of a variety of physical contexts for a corresponding customer. Examples include but are not limited to a retail shopping facility, the customer's home or place of employment, or effectively any other physical location of convenience. As used herein, it will be understood that a retail shopping facility comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

Generally speaking, this apparatus 2300 provides a customer an opportunity to view, potentially manipulate, and otherwise experience at least one virtual product. More particularly, in this illustrative example the control circuit 2305 can access information including a plurality of partiality vectors for a particular customer as well as virtual-reality presentation information for a plurality of items available for retail sale (available, for example, via one or more corresponding memories 2303) and select a particular one (or more) of the plurality of items to present to the customer via the virtual-reality user interface 2301 as a function, at least in part, of the partiality vectors.

The control circuit 2305 may select and present particular items to the customer via the virtual-reality user interface 2301 in response to any of a variety of triggering mechanisms. By one approach, for example, a customer enters a retail shopping facility, dons a virtual-reality headset, and identifies a generic category of product in which they have an interest. The customer may effect that identification via, for example, a menu-based selection mechanism supported by the virtual-reality user interface 2301, a voice-based input mechanism, or otherwise as desired.

As another example, a customer may previously have provided information regarding one or more product categories of interest prior to visiting the retail shopping facility. Upon arriving at the retail shopping facility and interacting with the virtual-reality user interface 2301, the customer identifies themselves and the control circuit 2305 retrieves the previously-entered information and uses that information to then employ the customer and product vectors as described above to select particular products to present to the customer via the virtual-reality user interface 2301.

As yet another example, the control circuit 2305 may simply select and present items to present to the customer as a function of any information the control circuit 2305 may access regarding products the customer may find of interest. As one simple example in these regards, the control circuit 2305 may have information indicating that a particular customer has children of a particular age. During a typical seasonal gift-giving time, for example, the control circuit 2305 may present to this customer one or more toys or games that are age appropriate for this customer's children even though the customer did not specifically request such product categories.

The above examples are intended to serve in an illustrative capacity and are not intended to suggest any particular limitations in these regards.

By one approach and as illustrated in FIG. 24, the virtual-reality user interface 2301 provides the user with a virtual product showroom experience 2400, a showroom being an interior space configured and arranged to display products, often in a manner that permits the customer to view products from various points of view and often in a manner that permits the customer to pick up, touch, or otherwise physically interact with one or more display products. In many cases a showroom presents products in an individualized matter and avoids bulk presentation of identical products. Depending upon their respective size, products may be displayed using elevated shelves, pedestals, or other display platforms.

By one approach, and as illustrated in FIG. 24, the displayed products 2401 are presented in an order of presentation that begins with a product (or products) that best accords with the customer's partiality vectors and where the order of presentation continues with products that increasingly less accord with the customer's partiality vectors. Using this approach, products that likely best align with the customer's own partialities appear closer than products that align less completely.

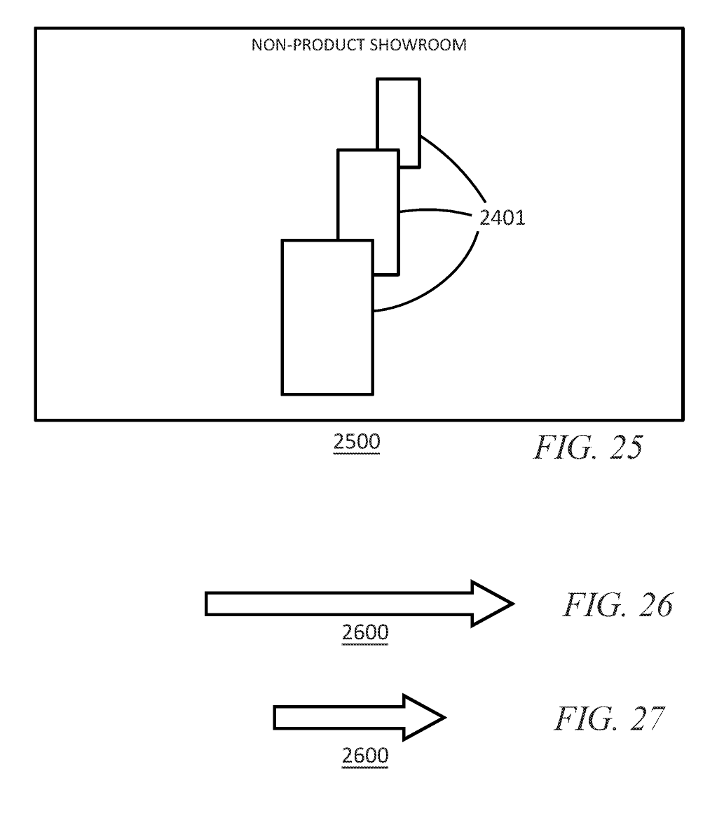

By another approach, and as illustrated in FIG. 25, the virtual-reality user interface 2301 provides the user with a virtual real-world setting other than in a product showroom (i.e., in a non-product showroom 2500). By one approach this virtual real-world setting comprises a real-world setting personal to the customer. Examples include virtual real-world settings based on interior or exterior spaces corresponding to the customer's home or office.

Information, such as still and video images, of the customer's own personal spaces can be provided by the customer on a voluntary basis to facilitate the foregoing presentation setting. In the absence of personalized settings, the virtual real-world setting can comprise other non-product showroom spaces such as furnished residential rooms, office spaces, interior vehicular spaces, residential back yards and front yards, park settings and other public spaces, and so forth as desired. By one approach the customer is provided with an opportunity to select from amongst a variety of such settings to use during a current shopping session.

As described above, these teachings will accommodate permitting a person to modify their partiality vectors and/or the information the control circuit 2305 utilizes to formulate their partiality vectors. If desired, the virtual-reality user interface 2301 can serve to facilitate such editing. FIGS. 26 and 27 provide an illustrative example in these regards. In this example, at least one of the customer's applicable partiality vectors 2600 appears in the virtual- reality presentation of the aforementioned products (for example, with the vector representation overlying the presented product or hovering above, to the side of, or below the corresponding presented product). The representation of the partiality vector 2600 can include, if desired, a textual or graphic indication to identify the partiality itself. In this case, and as shown in FIG. 27, the customer can shorten or elongate the magnitude of the vector 2600 by, for example, manipulating the length of the vector 2600 as presented in the virtual context using their index finger or other pointer.

It is also possible that a customer may wish to override a particular partiality without editing the partiality vector itself. Such may be the case when the customer is looking to purchase a gift for another person and the customer is therefore considering the gift recipient's partialities rather than their own. To accommodate that circumstance these teachings will accommodate configuring the control circuit 2305 to provide the customer with an opportunity to input at least one indication about what the customer values about a particular one of the presented items and to select another one of the plurality of available items to present to the customer via the virtual-reality user interface 2301 as a further function of that indication. In particular, the control circuit 2305 can employ the customer's indication to override an automatically-determined preference based on the customer's partiality vectors in favor of this new indication.

By one approach such overriding can always be treated only as a temporary override (to be used, for example, only during the present viewing/shopping session). By another approach the customer can be provided with an opportunity to select whether the new indication is to be utilized to modify the core information for the customer such that the modification applies going forward as well.

So configured, the ability of a virtual-reality setting to quickly present a customized view to a given person is greatly leveraged by selecting products to present in that setting based upon partiality vectors for that person.

As suggested above, in one illustrative approach, the apparatus, methods, and systems described herein provide customers, shoppers, or users a customized retail shopping experience based on the individual's user profile and the presence of that individual user in a particular area of the retail shopping facility. By one approach, the customized experience is facilitated in part, by having a virtual showroom with a virtual-reality user interface that that may be activated, adjusted, or changed in response to the presence or detection of the user in a virtual- reality enabled location within the retail shopping facility via one or more shopper detection sensors.

In one simple example, a user profile includes partiality vectors associated with kind treatment toward animals and an interest in minimizing environmental impacts, and the associated user walks into a virtual-reality enabled location in the personal care department. Based on this user's partiality vectors, the virtual-reality user interface, which may include an installed display screen or projector, may display information, advertisements, or other relevant information regarding a personal care product's lack of animal testing or sustainable manufacturing practices.

Accordingly, a virtual- or augmented- showroom can be presented to particular users at a physical retail shopping facility based on the particular user's partiality vectors. Further, as used herein, virtual reality is understood to include so-called augmented reality. Thus, these teachings may create a more traditional virtual-reality world, such as, for example, via a head-mounted audio-visual unit that may have three-dimensional aspects or may use display screens or projectors to augment the user's reality in a more two-dimensional manner.

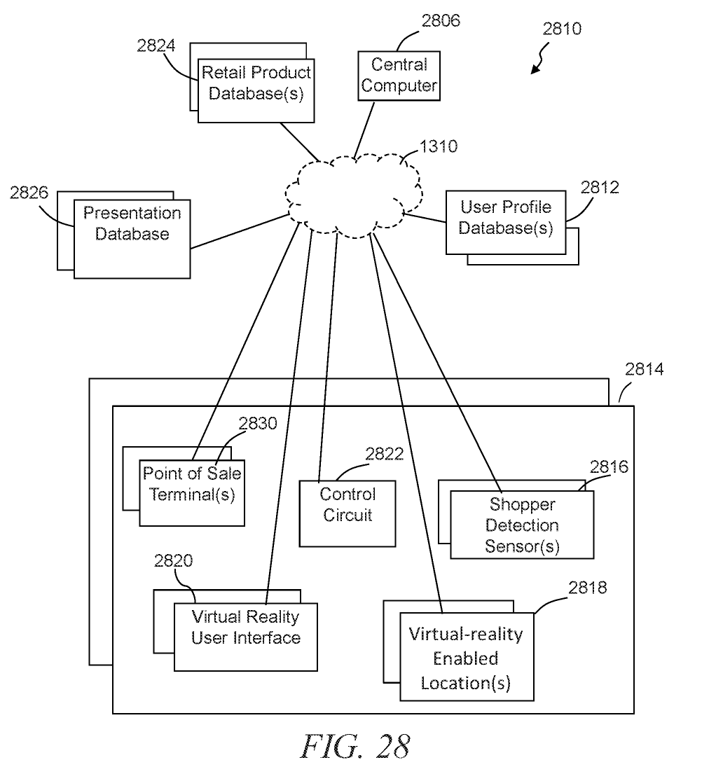

One exemplary shopping system 2810, illustrated in FIG. 28, includes shopper detection sensor(s) 2816, virtual-reality enabled location(s) 2818, virtual-reality user interface 2820, and a control circuit 2822 at a retail shopping facility 2814. Further, the retail shopping facility 2814 typically has a plurality of retail products displayed therein. As used herein, the virtual-reality user interface 2820 may include one or more user interface devices.

By one approach, the control circuit 2822 is configured to receive an indication, via the shopper detection sensor 2816, of the presence of a particular user within a virtual-reality enabled location 2818 and access the user profile database 2812 with the partiality vector(s) (and possibly other relevant information, such as, for example, a user shopping list) associated with the detected user. Furthermore, in one illustrative example, the control circuit 2822 instructs the virtual-reality user interface 2820 to adjust visual, audio, and/or haptic aspects of the virtual-reality user interface 2820, in part, in response to the detection of the user in the virtual-reality enabled location 2818 and the partiality vector(s) associated with the detected user.

In addition, the control circuit 2822 also may be configured to access a presentation database 2826 of virtual-reality presentation information and analyze the presentation database 2826, the user profile of a user, and the detected location of that user to determine what visual, audio, and/or haptic aspects to display or present to the user.

To facilitate the provision of a customized shopping experience, the system 2810 includes at least one shopper detection sensor 2816 configured to detect the presence of a user in areas within the retail shopping facility 2814. In one illustrative approach, the sensors 2816 detect movements of users in the retail shopping facility 2814 such that a particular user's presence in a virtual-reality enabled location is known. For example, the sensor 2816 may detect when a particular one of the users enters one or more virtual-reality enabled locations 2818 within the retail shopping facility 2814.

More particularly, the control circuit 2822 and the sensor 2816 may detect when a particular one of the users enters or is present in a virtual-reality enabled location 2818 and the partiality vectors associated with that particular user. The shopper detection sensor 2816 may have a variety of configurations, and may include, for example, RFID communications, cellular communications, Wi-Fi communications, or combinations thereof. Further, the system 2810 may include a plurality of sensors 2816 tracking movements of users within the retail shopping facility 314.

By one approach, the sensors 2816 may be configured to detect a user approaching a retail shopping facility 2814, such as via a geo-fence that notifies the central computer 2806 and/or the control circuit 2822 when the user is within a certain perimeter around a retail shopping facility 2814. A geo-fence also may be used around certain areas within the retail shopping facility 2814 such as around certain departments, aisles, and/or displays. Accordingly, a geo-fence may be configured to indicate when a particular user enters a retail shopping facility 2814 or one of the virtual-reality enabled locations 2818 therein.

In one illustrative example, the retail shopping facility 2814 include numerous virtual-reality enabled locations 2818 within the retail shopping facility 2814. In this manner, the provision of customized content may be based, in part, on a user's location within the retail shopping facility 2814, and it also may help users locate relevant products as they walk or wander around the retail shopping facility 2814. For example, the virtual-reality user interface 2820 may present directional or suggestive information about the path or progression of particular user based on the information in the associated user profile.

In another configuration, the sensors 2816 along with the shopping list in the user profile database can be used to facilitate an efficient shopping trip for a user. For example, the control circuit 2822 may be configured to select or pick the best route through a retail shopping facility 2814 based on the items on a user's shopping list and their location within the store as determined by the shopper detection sensors 2816. The efficient shopping route also may be updated during the shopping trip based on the current location of the user.

The shopping system 2810 also may include a user profile database 2812 having one or more partiality vectors associated with particular users (which may be similar to the memory 1306 of the vectorized characterizations 1307 of individual persons 1308) and a retail product database 2824 that may contain information about the various retail products displayed within the retail shopping facility 2814, such as, for example, identified vectorized product characterizations or product vectors (which may be similar to the library 411 or the memory 1303 with vectorized characterizations 1304 for products 1305. By one approach, the control circuit 2822 may analyze the user profiles in the user profile database 2812 and/or the product information in the retail product database 2824 to determine what display or information to present to the users in particular areas of the retail shopping facility 2814, as outlined below.

In one illustration, the control circuit 2822 is configured to access the databases 2812, 2826 to identify one or more suggested retail items for a particular user based, in part, on comparisons with the partialities of a particular user and the identified vectorized product characterizations of the retail products. Further, these identified products may be highlighted or displayed in a special manner when the user enters a virtual-reality enabled location 2818. In other approaches, the control circuit 2822 may choose to highlight or display information about products found on a user's shopping list.

As mentioned above, the user profiles in the user profile database 2812 may include a purchase history and/or a shopping list. Further, one or more of the purchased retail products may have at least one identified partiality associated therewith. In one approach, the control circuit 2822 is configured to identify the information to display to the detected user based, in part, on the purchase history of a particular user by having the partialities identified with the purchased items associated with the user. The user profiles in the database also may have partialities associated therewith based on other information, such as, for example, the rejection of a suggested item or demographic information, among many others. Other partialities may be identified by receiving specific requests from a user.

Given the information in the user profile database 2812 and the retail product database 2824, the control circuit 2822, in one approach, is configured to analyze the partiality vectors and the vectorized product characterizations and identify overlap therebetween. The suggested retail products that may be displayed to particular users may be determined based on this overlap. In this manner, the suggested retail products for a given customer may change based on changes in the user and product databases. For example, a change to the product database or the user database, may result in the different suggested retail items for a particular customer.

In one illustrative approach, the system 2810 includes one or more point of sale terminals 2830 in communication with the control circuit 2822 such that the system 2810 can update the user profile associated with the particular customer based, in part, on retail products purchased by the particular customer at the point of sale terminal 2830 and the vectorized product characterizations associated with those purchased retail products.

To facilitate the provision of visual, audio, and/or haptic information or feedback, the system 2810 includes a presentation database 2826 that includes video, audio, and/or haptic display information about various products and a central computer 2806 that may communicate with a plurality of different retail facilities 2814.

As illustrated in FIG. 28, the shopper detection sensor(s) 2816, the virtual-reality enabled locations 2818, the virtual-reality user interface 2820, the control circuit 2822, the user profile database 2812, the retail product database 2824, the point of sale terminal 2830, the presentation database 2826, and the central computer 2806, if present, may be communicatively coupled, either directly or indirectly, such as over one or more distributed communication networks 1310, which may include, for example, LAN, WAN, Internet, cellular, Wi-Fi, and other such communication networks or combinations of two or more of such networks.

To facilitate the provision of a customized shopping experience, the system 2810 includes a virtual-reality user interface 2820 that is configured to display visual, audio, and/or haptic information (such as product information or advertisements) pertaining to retail products. As noted above, the virtual-reality user interface 320 may include one or more devices that may be installed at one or more virtual-reality enabled location 2818 in the retail shopping facility 2814 or mobile such that they can be used throughout the facility at several virtual-reality enabled locations 2818. By one approach, an installed virtual-reality user interface 2820 may include a kiosk that is installed at a particular aisle in a retail shopping facility. By yet another approach, a mobile, virtual-reality user interface 2820 may advance into the virtual-reality enabled location 2818 with the user, such as, for example, when the user is wearing or carrying the virtual-reality user interface 2820, or a portion thereof. In this manner, the virtual-reality user interface 2820 provide an augmented reality elements in a physical user environment found in the retail shopping facility 2814.

The virtual-reality user interface 2820 may be configured to adjust audio, visual, and/or haptic aspects of the interface and change the display of retail products based, in part, on the partiality vectors associated with the particular users within the virtual-reality enabled location 2818 thereby highlighting products of interest to the particular users. In addition, the virtual-reality user interface 2820 may receive information from the particular user and adjust the audio, visual, and/or haptic aspects of the interface accordingly.

As suggested, the virtual-reality user interface 2820 may include a handheld device, a wearable device, or an installed device installed into one of the virtual-reality enabled locations 2818. More specifically, the virtual-reality user interface 2820 may include one or more of the following devices: data eyewear, such as data glasses, a touch screen, a graphical user interface, a display screen, one or more digital projectors, spatial augmented reality projectors, a speaker, headphones, lights, a haptic feedback device, a microphone, a camera, an optical sensor, a tactile electronic display, an accessory object, a head-mounted audio-visual display, and/or a kiosk.

While in one approach, the virtual-reality user interface 2820 may include lights on aisle shelves and voice prompts, another virtual-reality user interface 2820 may include cameras or optical sensors. In this manner, the different virtual-enabled locatio618 may have different devices associated therewith. Depending on the devices incorporated therein, the virtual-reality user interface 2820 may receive information from the particular one of the users and further adjust the audio, visual and/or haptic aspects of a particular display.

Further, the devices incorporated into the virtual-reality user interface 2820 impact the type of display and information that can be provided to the users. For example, if a data glove or portion thereof is incorporated into the virtual-reality user interface 2820, the display may be configured to provide haptic information about a variety of different fabrics available. Accordingly, the presentation database 2826 may have a variety of presentation information that permits the control circuit 2822 to tailor or adjust the visual, audio, and/or haptic aspects of the presentation based on the particular devices incorporated into the virtual- reality user interface 2820.

In one illustrative approach, the virtual-reality user interface 2820 may include data eyewear, such as data glasses, that overlay information onto the user's visual perception of the area. As the user wearing such data eyewear walks through a virtual-reality enabled location 2818, a display visually overlaid on the user's visual surroundings may be updated accordingly. For example, the data eyewear may be able to provide instructions or highlight information about products within the particular user's view, via the data eyewear.

In another exemplary approach, the virtual-reality user interface 2820 may include installed projectors and speakers at a virtual-reality enabled location 2818 and this installation may be configured to present a display tailored to a particular user when that user is detected within the virtual-reality enabled location 2818. Furthermore, the presentation may be a customized display based on the particular detected user's partiality vectors as presently captured in the user profile database. For example, display items and/or information presented in the installation may be moved or adjusted based on a particular user's presence within the virtual-reality enabled location 2818 and the partiality vectors associated with that user

The virtual-reality user interface 2820 or portions thereof may be installed into the virtual-reality enabled locations 2818, may be mobile, or a combination thereof. In this manner, the virtual-reality user interface 2820, the virtual-reality enabled locations 2818, and the sensor(s) 2816, permit a physical retail shopping facility 2814 to provide a virtual showroom providing information, advertising, and an otherwise improved shopping experience, such as by permitting the user to more quickly and conveniently shop from a shopping list.

By one approach, the virtual-reality user interface 2820 of the system 2810 includes a payment module that enables a user to submit payment for purchase of one or more retail products. By another approach, the retail shopping facility 2814 may include a point of sale terminal 2830 in communication with the control circuit 2822 and/or the central computer 2806. Furthermore, the purchase information obtained from the point of sale terminal 2830 and any payment module associated with the virtual-reality user interface 2820 may be used to update the user's associated profile in the user database accordingly.

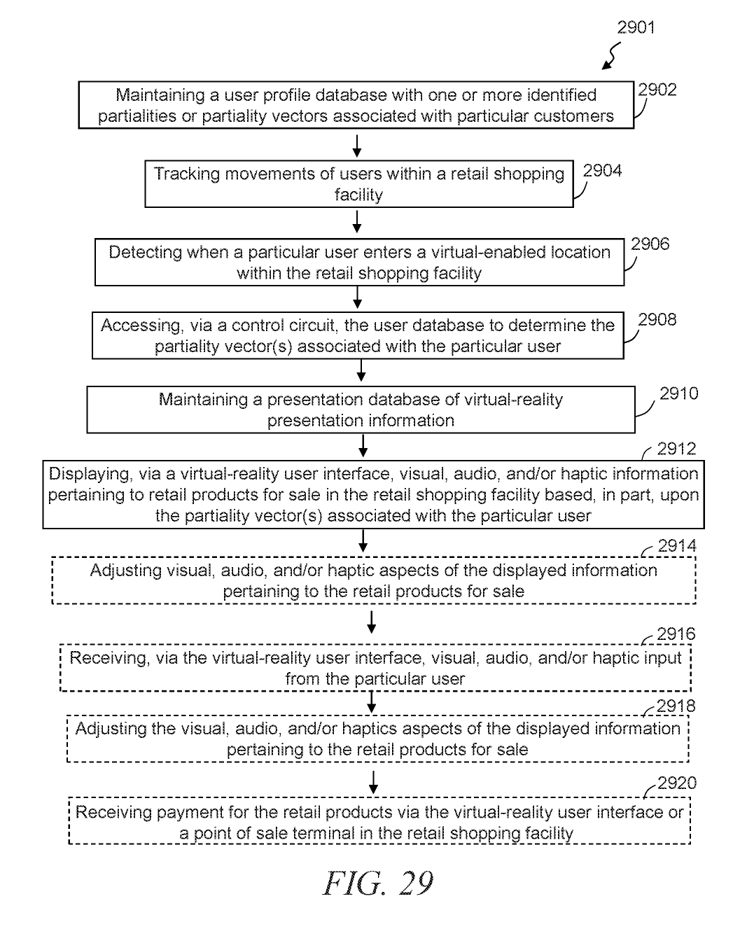

Turning now to FIG. 29, a method 2901 for providing a virtual showroom as described herein is illustrated. The method 2901 includes, for example, maintaining 2902 a user database having one or more partialities or partiality vectors associated with particular users. As noted above, the partialities may be represented by partiality vectors such that a customer's values, preferences, and affinities are captured in the particular user profile in the database. Also, the user profile may include numerous partiality vectors for a particular customer.

The method 2901 also includes tracking movements 2904 of users within a retail shopping facility and detecting 2906 when a particular user enters a virtual-reality enabled location within the retail shopping facility. In one illustrative example, the method 2901 includes accessing 2908, such as via a control circuit, the user database to determine the one or more partiality vectors associated with the particular user and displaying 2912, such as via a virtual-reality user interface, visual, audio, and/or haptic information pertaining to retail products for sale in the retail shopping facility based, in part, upon the one or more partiality vectors associated with the particular user.

In step 2914, the method 2901 may further include adjusting visual, audio, and/or haptic aspects of the displayed information pertaining to the retail products for sale.

In step 2916, the method 2901 may further include receiving, such as via the virtual-reality user interface, audio, visual, and/or haptic input from the particular user. Further, the method 2901 may include adjusting 2918 the visual, audio, and/or haptic aspects of the displayed information in response to the input received from the user. The user profile, including the partiality vectors, also may be updated in response to input received via the virtual-reality user interface.

In addition, the method 2901 may further include receiving payment for a retail product via the virtual-reality user interface or a point of sale terminal in the retail shopping facility.

Pursuant to these teachings, the method also includes maintaining 2910 a presentation database of virtual-reality presentation information that includes display details that are used to provide the audio, visual, and/or haptic display information to users. In this manner, the method uses a virtual-reality user interface to augment a physical user environment within the retail shopping facility.

Some embodiments provide shopping display systems comprising: a retail shopping facility having a plurality of retail products displayed therein; a user database of user profiles, the user profiles having one or more partiality vectors associated with particular users; at least one sensor detecting movements of users in the retail shopping facility, the sensor detecting when a particular one of the users enters one or more virtual-reality enabled locations within the retail shopping facility; a virtual-reality user interface at the retail shopping facility at the one or more virtual-reality enabled locations and configured to display visual, audio, or haptic information pertaining to retail products; a control circuit in communication with the user database and the virtual-reality user interface, the control circuit configured to: receive an indication, via the at least one sensor, of a presence of the particular one of the users within a virtual-enabled location; access the user database and the one or more partiality vectors associated with the particular one of the users within the virtual-reality enabled location; and instruct the virtual-reality user interface to adjust visual, audio, or haptic aspects of the virtual- reality user interface, in part, in response to the detection of the particular one of the users in the virtual-enabled location and the partiality vectors associated with the particular user. In some implementations, the virtual-reality user interface is configured to adjust audio, visual, or haptic aspects of the virtual-reality user interface and change the display of retail products based, in part, on the one or more partiality vectors associated with the particular one of the users within the virtual-reality enabled location thereby highlighting products of interest to the particular one of the users. Further, the virtual-reality user interface may comprise at least one of: a handheld device, a wearable device, or an installed device installed into one of the virtual-reality enabled locations within the retail shopping facility.

The virtual-reality user interface, in some embodiments, comprises at least one of: data eyewear, a touch screen, a graphical user interface, a display screen, one or more digital projectors, spatial augmented reality projectors, a speaker, headphones, lights, a haptic feedback device, a microphone, a camera, an optical sensor, a tactile electronic display, an accessory object, a head-mounted audio-visual display, and a kiosk. Further, the virtual-reality user interface may be configured to receive information from the particular one of the users and further adjust the audio, visual or haptic aspects of a particular display. Some embodiments further comprise a geo-fence configured to indicate when the particular one of the users enters the retail shopping facility or one of the virtual-reality enabled locations. The at least one sensor may employ at least one of: RFID, cellular, or Wi-Fi communications. The control circuit may further be configured to access a presentation database of virtual-reality presentation information and analyze the presentation database, the user profile of the particular user, and the detected location of the particular one of the users.

In some embodiments the system further comprises a plurality of sensors tracking movements of users within the retail shopping facility. The virtual-reality user interface can include a payment module enabling purchase of one of the retail products. The system may further comprise a point of sale terminal in communication with the control circuit and the control circuit updating the user database according to purchase made by the particular one of the users at the point of sale terminal. The user database, in some implementations, includes a shopping list for the particular one of the users. The virtual-reality user interface may be configured to provide augmented-reality elements in a physical user environment.

Some embodiments provide methods comprising: maintaining a user database of user profiles having one or more partiality vectors associated with particular users; tracking movement of users within a retail shopping facility; detecting when a particular user enters a virtual-enabled location within the retail shopping facility; accessing, via a control circuit, the user database to determine the one or more partiality vectors associated with the particular user; and displaying, via a virtual-reality user interface, visual, audio, or haptic information pertaining to retail products for sale in the retail shopping facility based, in part, upon the one or more partiality vectors associated with the particular user. The method may further comprise adjusting visual, audio, or haptic aspects of the displayed information pertaining to the retail products for sale. In some instances, the method comprises receiving, via the virtual-reality user interface, audio, visual, or haptic input from the particular user. The method may further comprises adjusting the visual, audio, or haptic aspects of the displayed information pertaining to the retail products for sale. Some embodiments comprise maintain a presentation database of virtual-reality presentation information. In some applications, the method comprises receiving payment for at least one of the retail products via the virtual-reality user interface or a point of sale terminal in the retail shopping facility. The virtual-reality user interface may further augment a physical user environment within the retail shopping facility.

In some embodiments, an apparatus comprises a virtual-reality user interface, a memory containing virtual-reality presentation information for a plurality of items available for retail sale as well as information including a plurality of partiality vectors for a particular customer, and a control circuit that operably couples to both the virtual-reality user interface and the memory. The control circuit selects a particular one of the plurality of items to present to the customer via the virtual-reality user interface as a function, at least in part, of the partiality vectors. The virtual-reality user interface can include, for example, an audio-content user interface and/or an active haptic-content user interface along with a visual interface. By one approach the control circuit presents particular ones of the plurality of items in an order of presentation that begins with a product that best accords with the customer's partiality vectors.

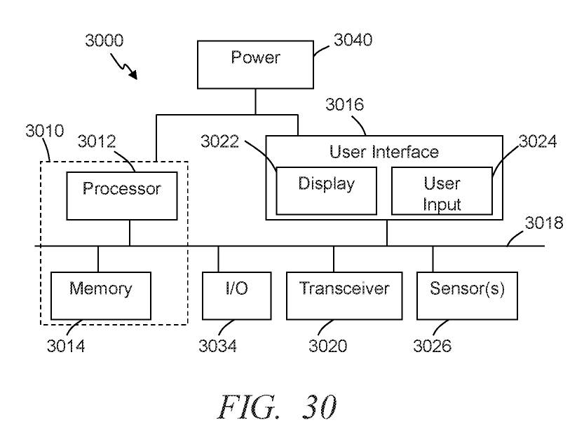

Further, the circuits, circuitry, systems, devices, processes, methods, techniques, functionality, services, servers, sources and the like described herein may be utilized, implemented and/or run on many different types of devices and/or systems. FIG. 30 illustrates an exemplary system 3000 that may be used for implementing any of the components, circuits, circuitry, systems, functionality, apparatuses, processes, or devices of customer support system 1800, and/or other above or below mentioned systems, circuits, or devices, or parts of such circuits, circuitry, functionality, systems, apparatuses, processes, or devices. For example, the system 3000 may be used to implement some or all of central control system 1802, the central control system 2002, the control circuit1302, the control circuit 2305, central computer 2806, point terminal 2830, the virtual reality user interface 2820, the rendering systems 1804, the rendering systems 2004, the inventory system 1814, the inventory system 2014, the sensors 1816, user interface units 1818, and/or other such components, circuitry, functionality and/or devices. However, the use of the system 3000 or any portion thereof is certainly not required.

By way of example, the system 3000 may comprise a control circuit or processor module 3012, memory 3014, and one or more communication links, paths, buses or the like 3018. Some embodiments may include one or more user interfaces 3016, and/or one or more internal and/or external power sources or supplies 3040. The control circuit 3012 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 3012 can be part of control circuitry and/or a control system 3010, which may be implemented through one or more processors with access to one or more memory 3014 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 3000 may be used to implement one or more of the above or below, or parts of, components, circuits, systems, processes and the like. For example, the system may implement the central control system 1802 with the control circuit being a central control circuit, the rendering system 1804 with a rendering control circuit, a user interface unit with the user interface control circuit, or other components.

The user interface 3016 can allow a user to interact with the system 3000 and receive information through the system. In some instances, the user interface 3016 includes a display 3022 and/or one or more user inputs 3024, such as buttons, touch screen, track ball, keyboard, mouse, etc., which can be part of or wired or wirelessly coupled with the system 3000. Typically, the system 3000 further includes one or more communication interfaces, ports, transceivers 3020 and the like allowing the system 3000 to communicate over a communication bus, a distributed computer and/or communication network 1310 (e.g., a local area network (LAN), the Internet, wide area network (WAN), etc.), communication link 3018, other networks or communication channels with other devices and/or other such communications or combination of two or more of such communication methods. Further the transceiver 3020 can be configured for wired, wireless, optical, fiber optical cable, satellite, or other such communication configurations or combinations of two or more of such communications. Some embodiments include one or more input/output (I/O) ports 3034 that allow one or more devices to couple with the system 3000. The I/O ports can be substantially any relevant port or combinations of ports, such as but not limited to USB, Ethernet, or other such ports. The I/O interface 3034 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 3026 to provide information to the system and/or sensor information that is communicated to another component, such as the central control system, rendering system, user interface units, etc. The sensors can include substantially any relevant sensor, such as radio frequency identification (RFID) tag reader sensors capable of reading RFID tags in proximity to the sensor, optical based scanning sensors to sense and read optical patterns (e.g., bar codes), cameras, infrared sensors, distance measurement sensors (e.g., optical units, sound/ultrasound units, etc.), and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 3000 comprises an example of a control and/or processor-based system with the control circuit 3012. Again, the control circuit 3012 can be implemented through one or more processors, controllers, central processing units, logic, software and the like. Further, in some implementations the control circuit 3012 may provide multiprocessor functionality, which may be located at a single location or implemented through distributed processing at a combination of two or more locations.

The memory 3014, which can be accessed by the control circuit 3012, typically includes one or more processor readable and/or computer readable media accessed by at least the control circuit 3012, and can include volatile and/or nonvolatile media, such as RAM, ROM, EEPROM, flash memory and/or other memory technology. Further, the memory 3014 is shown as internal to the control system 3010; however, the memory 3014 can be internal, external or a combination of internal and external memory. Similarly, some or all of the memory 3014 can be internal, external or a combination of internal and external memory of the control circuit 3012. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 1310. The memory 3014 can store code, software, executables, scripts, data, content, lists, programming, programs, log or history data, user information, customer information, product information, and the like. While FIG. 30 illustrates the various components being coupled together via a bus, it is understood that the various components may actually be coupled to the control circuit and/or one or more other components directly.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/395,677 filed Sep. 16, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; Ser. No. 15/606,602 filed May 26, 2017; Ser. No. 15/624,030 filed Jun. 15, 2017; Ser. No. 15/625,599 filed Jun. 16, 2017; Ser. No. 15/628,282 filed Jun. 20, 2017; 62/523,148 filed Jun. 21, 2017; 62/525,304 filed Jun. 27, 2017; Ser. No. 15/634,862 filed Jun. 27, 2017; and Ser. No. 15/655,339 filed Jul. 20, 2017.

What is claimed is:

1. A system to support customers while shopping, comprising:
a plurality of virtual reality rendering systems positioned within a retail shopping facility;
a field of expertise database associating each of multiple products with one or more of multiple different fields of expertise and with one of multiple different virtual reality environments each corresponding to one of the fields of expertise and that correspond to an environment in which the product is expected to be used;
a central control system comprising a central control circuit coupled with memory storing code that when implemented causes the central control circuit to:
identify a first product for which a first customer is requesting expert advice on how to use the first product;
access the field of expertise database and identify a first field of expertise associated with the first product;
access a virtual reality content database and acquire a first set of code to be applied in rendering a first virtual reality environment corresponding to the first field of expertise and the first product; and
distribute the first set of code to a first rendering system of the plurality of rendering systems corresponding to the first customer to cause the first rendering system to visually render the first virtual reality environment and a first expert avatar that appears as an expert in the first field of expertise and that virtually illustrates at least how to correctly use the first product within a physical environment represented by the first virtual reality environment.

2. The system of claim 1, wherein the central control circuit is further configured to:
receive, while the customer is in the shopping facility and viewing the rendered first expert avatar depicted within the first virtual reality environment, input from the first customer corresponding to a desired modification of a visual orientation of the first product relative to its virtual use by the first expert avatar; and
cause a second set of code to be distributed to the first rendering system to cause a modification to the first customer's visual orientation relative to the rendered first product and the first expert avatar.

3. The system of claim 1, further comprising:
an expert database identifying multiple publically known experts and associating one or more fields of expertise with each of the experts for which each of the experts is publically considered to be an expert; and
wherein the central control circuit is configured to select, from the expert database, the first expert that is generally considered by the general public to be an expert in the first field of expertise, and in the causing of the rendering of the avatar causes the rendering of the avatar to appear as the first publically known expert.

4. The system of claim 1, further comprising:
a series of sensors positioned and distributed in multiple locations in the shopping facility that communicate sensor information to the central control system;
wherein the central control system is communicatively coupled with the series of sensors, and in identifying the first product, is further configured to identify the first product being touched by the first customer based on sensor information received from at least one of the series of sensors.

5. The system of claim 1, further comprising:
a customer database comprising an identifier for each of multiple customers, and for each customer associates customer partiality vectors with the customer, wherein the customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order;
wherein the central control system in identifying the first field of expertise further identifies the first field of expertise based on a partiality vector defined for the first customer.

6. The system of claim 5, wherein the central control system further identifies, based on the partiality vectors associated with the first customer, adjustable characteristics corresponding to the first product and consistent with the partiality vectors wherein the distribution of the first set of code comprises distributing the first set of code as defined in part by the adjustable characteristics and to cause the visually rendering of the first product consistent with the adjustable characteristics.

7. The system of claim 1, wherein the central control circuit in distributing the first set of code causes the rendering of how components of the first product operate together and based on the intended use of the first product further recommends other products to be used with the first product and further causes a virtual rendering of at least one of the other products in use with the first product within the first virtual reality environment.

8. The system of claim 7, further comprising:
a series of sensors positioned and distributed in multiple locations in the shopping facility that communicate sensor information to the central control system;
wherein the central control system is communicatively coupled with the series of sensors and configured to:
receive the sensor information;
identify the first customer;
identify a location within the shopping facility of the first customer based on the sensor information;
identify, based on the location within the shopping facility and products located proximate the location, the first virtual reality environment and the first field of expertise that is to be rendered to the first customer.

9. A method of supporting customers while shopping, comprising:
by a central control circuit of a shopping facility:
identifying a first product for which a first customer is requesting expert advice on how to use a first product;
accessing a field of expertise database and identifying a first field of expertise associated with the first product, wherein the field of expertise database associates each of multiple products with one or more of multiple different fields of expertise and with one of multiple different virtual reality environments each corresponding to one of the fields of expertise and that correspond to an environment in which the product is expected to be used;
accessing a virtual reality content database and acquiring a first set of code to be applied in rendering a first virtual reality environment corresponding to the first field of expertise and the first product; and
distributing the first set of code to a first rendering system, of a plurality of rendering systems positioned within a retail shopping facility, corresponding to the first customer and causing the first rendering system to visually render the first virtual reality environment and a first expert avatar that appears as an expert in the first field of expertise and that virtually illustrates at least how to correctly use the first product within a physical environment represented by the first virtual reality environment.

10. The method of claim 9, further comprising:
receiving, while the customer is in the shopping facility and viewing the rendered first expert avatar depicted within the first virtual reality environment, input from the first customer corresponding to a desired modification of a visual orientation of the first product relative to its virtual use by the first expert avatar; and
causing a second set of code to be distributed to the first rendering system to cause a modification to the first customer's visual orientation relative to the rendered first product and the first expert avatar.

11. The method of claim 9, further comprising:
selecting the first expect, from an expert database identifying multiple publically known experts and associating one or more fields of expertise with each of the experts for which each of the experts is publically considered to be an expert, wherein the first expert is identified in the expert database as generally considered by the general public to be an expert in the first field of expertise; and
wherein the causing the rendering of the avatar comprises causing the rendering of the avatar to appear as the first publically known expert.

12. The method of claim 9, further comprising:
receiving sensor information from at least one sensor of a series of sensors positioned and distributed in multiple locations in the shopping facility;
wherein the identifying the first product further comprises identifying the first product being touched by the first customer based on the sensor information received from the at least one sensor of the series of sensors.

13. The method of claim 9, further comprising:
identifying the first customer; and
accessing a customer database comprising an identifier for each of multiple customers, and for each customer associates customer partiality vectors with the customer, wherein the customer partiality vectors are directed quantities that each have both a magnitude and a direction, with the direction representing a determined order imposed upon material space-time by a particular partiality and the magnitude represents a determined magnitude of a strength of the belief, by the first customer, in a benefit that comes from that imposed order;
wherein the identifying the first field of expertise further comprises identifying the first field of expertise based on a partiality vector defined for the first customer.

14. The method of claim 13, further comprising:
identifying, based on the partiality vectors associated with the first customer, adjustable characteristics corresponding to the first product and consistent with the partiality vectors;
wherein the distributing of the first set of code comprises distributing the first set of code as defined in part by the adjustable characteristics and causing the visually rendering of the first product consistent with the adjustable characteristics.

15. The method of claim 9, further comprising:
identifying other products to be recommended for used with the first product; and
wherein the distributing the first set of code comprises distributing the first set of code causing the rendering of how components of the first product operate together and based on the intended use of the first product further causes a virtual rendering of at least one of the other products in use with the first product within the first virtual reality environment.

16. The method of claim 15, further comprising:
receiving sensor information from at least one sensor of a series of sensors positioned and distributed in multiple locations in the shopping facility;
identifying the first customer;
identifying a location within the shopping facility of the first customer based on the sensor information;
identifying, based on the location within the shopping facility and products located proximate the location, the first virtual reality environment and the first field of expertise that is to be rendered to the first customer.
